(19) United States
(12) Patent Application Publication
(10) Pub. No.: US 2026/0164377 A1
(43) Pub. Date: Jun. 11, 2026

(54) SYSTEMS AND METHODS FOR THE PROVISIONING OF REFERENCE TIME INFORMATION FOR TIME SYNCHRONIZATION

(71) Applicant: Telefonaktiebolaget LM Ericsson (PUBL), Stockholm (SE)

(72) Inventors: Yufei Blankenship, KILDEER, IL (US); Zhenhua ZOU, Sollentuna (SE); Siva MURUGANATHAN, STITTSVILLE (CA)

(21) Appl. No.: 18/706,462

(22) PCT Filed: Nov. 24, 2022
(86) PCT No.: PCT/IB2022/060638

§ 371 Date: May 1, 2024

Related U.S. Application Data
(60) Provisional application No. 63/263,619, filed on Nov. 5, 2021.

(51) Int. Cl. H04W 56/00

(52) U.S. Cl. CPC H04W 56/0015

(57) ABSTRACT

A method (1000) by a wireless device (412) for time synchronization includes receiving (1002) time information from a network node (410). The time information includes at least one reference time value for time synchronization and an indication of at least one transmission/reception point, TRP, associated with the time information.

### TECHNICAL FIELD

The present disclosure relates, in general, to wireless communications and, more particularly, systems and methods for the provisioning of reference time information for time synchronization.

### BACKGROUND

In 3rd Generation Partnership Project (3GPP) Release 16, 3GPP SA2 and RAN2 have aimed at providing support for Time Sensitive Networking (TSN) such that the 5^{th} Generation System (5GS) can operate as a TSN logical bridge between TSN-based network elements. Successful 5G-TSN integration to support time critical industrial application requires end-to-end time synchronization. Time reference information (e.g., a TSN Grandmaster Clock) is needed for the applications running in end devices in most of the industrial automation deployments. The same or an additional type of time reference information is also required in the bridges of a TSN network (e.g., to realize an ingress to egress traffic delay target for a TSN bridge) when time-based TSN tools are used, like Scheduled Traffic (802.1Qbv), to provide deterministic low latency for time-critical traffic.

Time synchronization requirements from vertical industries has been defined by 3GPP specifications 3GPP TS 22.104 v18.2.0. Table 1, which corresponds to Table 5.6.2-1 of 3GPP TS 22.104 v18.2.0, shows a diverse set of clock synchronization service performance requirements for 5GS.

TABLE 1
Clock synchronization service performance requirements for 5GS

| User-specific | | 5GS | | | | |
|---|---|---|---|---|---|---|
| clock | Number of devices in | synchronicity | | | | |
| synchronicity | one communication | budget | | | | |
| accuracy | group for clock | requirement | | | | |
| level | synchronisation | (note 1) | | Service area | | Scenario |
| 1 | up to 300 UEs | ≤900 | ns | ≤100 m × | | Motion control (A.2.2.1) |
| | | | | 100 m | | Control-to-control communication |
| | | | | | | for industrial controller (A.2.2.2) |
| 2 | up to 300 UEs | ≤900 | ns | ≤1, 000 m × | | Control-to-control communication |
| | | | | 100 m | | for industrial controller (A.2.2.2) |
| 3 | up to 10 UEs | <10 | μs | ≤2, 500 | m² | High data rate video streaming |
| 3a | up to 100 UEs | <1 | μs | ≤10 | km² | AVPROD synchronisation and packet |
| | | | | | | timing |
| 4 | up to 100 UEs | <1 | μs | <20 | km² | Smart Grid: synchronicity between |
| | | | | | | PMUs |
| 4a | up to 100 UEs | <250 ns to | | <20 | km² | Smart Grid: IEC 61850-9-2 Sampled |
| | | 1 μs | | | | Values |
| 4b | up to 100 UEs | <10-20 | μs | <20 | km² | Smart Grid: IEC 61850-9-2 Sampled |
| | | | | | | Values - Power system protection |
| | | | | | | in digital substation |
| 4c | 54/km² (note 2) | <10 | μs | several km² | | Smart Grid: Intelligent Distributed |
| | 78/km² (note 3) | | | | | Feeder Automation (A.4.4.3) |
| 4d | up to 100 UEs | <1 | ms | <20 | km² | Smart Grid: IEC 61850-9-2 Sampled |
| | | | | | | Values - Event reporting and |
| | | | | | | Disturbance recording |
| 5 | up to 10 UEs | <50 | μs | 400 | km | Telesurgery (A.6.2) and telediagnosis |

(A.6.3)
NOTE 1:
The clock synchronicity requirement refers to the clock synchronicity budget for the 5G system, as described in Clause 5.6.1.
NOTE 2:
When the distributed terminals are deployed along overhead line, about 54 terminals will be distributed along overhead lines in one square kilometre. The resulting power load density is 20 MW/km².
NOTE 3:
When the distributed terminals are deployed in power distribution cabinets, there are about 78 terminals in one square kilometre. The resulting power load density is 20 MW/km²,

For integration with TSN, the 5GS is considered as a virtual bridge. For time synchronization support, such a 5G virtual bridge is modelled as a time-aware system as per IEEE 802.1AS. There are two synchronization processes running in parallel in an integrated 5G-TSN system: a 5GS internal synchronization process (i.e., distribution of a 5^{th} Generation (5G) internal clock required to realize ingress to egress traffic delay targets for a 5GS) and a TSN synchronization process (i.e., needed to realize synchronization between a TSN Grandmaster clock source and devices reachable through the 5GS).

The two synchronization processes can be considered independent from each other. The gNB only needs to be aware of and synchronized to the 5G reference clock as this is sufficient for the 5GS internal synchronization process to be kept intact, functioning and independent of TSN synchronization process (i.e. the external generalized Precision Time Protocol (gPTP) synchronization process which makes use of gPTP Grand Master clocks delivered transparently through the 5GS).

### 5GS Internal Synchronization

The use of time synchronization has been common practice already for cellular networks of different generations and is an integral part of operating 5G cellular radio systems. The 5G radio network components themselves are also time synchronized, e.g., for advanced radio transmission, such as synchronized Time Division Duplex (TDD) operation, cooperative multipoint (CoMP) transmission, or carrier aggregation (CA). The new 5G capability introduced when integrating 5G systems and TSN networks is to provide 5G internal clock (reference time) delivery as a service over the 5G system (5GS).

FIG. 1 illustrates gNB System Frame Number (SFN) Transmissions.

Once the 5G reference time is acquired by a gNodeB (gNB) (e.g. from a Global Positioning System (GPS) receiver), it is sent to different nodes in the 5G network with the goal of introducing as little synchronicity error (uncertainty) as possible when distributing it. The distribution of 5G reference time information to user equipments (UEs) is designed to exploit the existing synchronized operation inherent to the 5G radio access network. Such a building block approach enables end-to-end time synchronization for industrial applications communication services running over 5GS.

The gNB maintains the acquired 5G reference time on an ongoing basis as well as periodically projecting the value it will have when a specific reference point in the system frame structure (e.g. at the end of SFN_{z}) occurs at the gNB Antenna Reference Point (ARP) (shown as reference point t_{R} in FIG. 1).

A Radio Resource Control (RRC) broadcast message or RRC unicast message containing the projected reference time value and the corresponding reference point (the value of SFN_{z}) is transmitted during SFNₓ and received by a UE in advance of t_{R}. For example, it may be broadcasted to all UEs in System Information Block (SIB9). As another example, it may be transmitted via unicast to individual UE in a DLInformationTransfer message.

The message used to send the 5G reference time information may also contain an uncertainty value to indicate to the UE the expected error (uncertainty) that the indicated 5G reference time value (applicable to the reference point t_{R}) is expected to have. The uncertainty value reflects (a) the accuracy with which a gNB implementation can ensure that the indicated reference time corresponding to reference point t_{R} (the end of SFN_{z}) will reflect the actual time when that reference point occurs at the ARP and (b) the accuracy with which the reference time can be acquired by the gNB. The uncertainty introduced by (a) is implementation specific but is expected to be negligible and is therefore not further considered.

The reference time information is transmitted in the RRC information element (IE) ReferenceTimeInfo. The details are shown below:

ReferenceTimeInfo information element

-- ASN1START
-- TAG-REFERENCETIMEINFO-START
ReferenceTimeInfo-r16 ::= SEQUENCE {

| time-r16 | ReferenceTime-r16, | |
|---|---|---|
| uncertainty-r16 | INTEGER (0..32767) | OPTIONAL, -- |

Need S

| | | |
|---|---|---|
| timeInfoType-r16 | ENUMERATED {localClock} | OPTIONAL, -- |

Need S

| | | |
|---|---|---|
| referenceSFN-r16 | INTEGER (0..1023) | OPTIONAL -- |

Cond RefTime
}

| | |
|---|---|
| ReferenceTime-r16 ::= | SEQUENCE { |
| refDays-r16 | INTEGER (0..72999), |
| refSeconds-r16 | INTEGER (0..86399), |
| refMilliSeconds-r16 | INTEGER (0..999), |
| refTenNanoSeconds-r16 | INTEGER (0..99999) |

}
-- TAG-REFERENCETIMEINFO-STOP
-- ASN1STOP

ReferenceTimeInfo field descriptions

referenceSFN
This field indicates the reference SFN corresponding to the reference time information. If
referenceTimeInfo field is received in DLInformationTransfer message, this field indicates
the SFN of PCell.
time
This field indicates time reference with 10 ns granularity. The indicated time is referenced at
the network, i.e., without compensating for RF propagation delay. The indicated time in 10 ns
unit from the origin is refDays*86400*1000*100000 + refSeconds*1000*100000 +
refMilliSeconds*100000 + refTenNanoSeconds. The refDays field specifies the sequential
number of days (with day count starting at 0) from the origin of the time field.
If the referenceTimeInfo field is received in DLInformationTransfer message, the time field
indicates the time at the ending boundary of the system frame indicated by referenceSFN.
The UE considers this frame (indicated by referenceSFN) to be the frame which is nearest
to the frame where the message is received (which can be either in the past or in the future).
If the referenceTimeInfo field is received in SIB9, the time field indicates the time at the SFN
boundary at or immediately after the ending boundary of the SI-window in which SIB9 is
transmitted.
If referenceTimeInfo field is received in SIB9, this field is excluded when determining
changes in system information, i.e. changes of time should neither result in system
information change notifications nor in a modification of valueTag in SIB1.
timeInfoType
If timeInfoType is not included, the time indicates the GPS time and the origin of the time
field is 00:00:00 on Gregorian calendar date 6 Jan., 1980 (start of GPS time). If
timeInfoType is set to localClock, the origin of the time is unspecified.
uncertainty
This field indicates the uncertainty of the reference time information provided by the time
field. The uncertainty is 25 ns multiplied by this field. If this field is absent, the uncertainty is
unspecified.

### Propagation Delay Compensation

In an industrial use case where the provision of industrial clock synchronization service is supported through the 5GS, the 5GS is in practice only allowed to contribute a portion of the maximum end-to-end synchronicity budget (uncertainty budget) allowed for any given TSN Grandmaster clock. There are many uncertainty components in the 5GS, including the UE internal synchronization error budget, and the synchronization error budget associated with delivering the 5G internal clock to the user plane function (UPF) and the UE.

The biggest 5GS synchronization error introduced is when the 5G internal clock is delivered to a UE from the gNB via the Uu interface. It occurs on the air interface and is due to the error from unknown propagation delays. In some large cells, the propagation delay from the gNB to the UE can be 1 us or larger (i.e., the distance from the gNB to the UE is 300 meters or more). Without any propagation delay compensation applied to the 5G internal clock, it is not possible to meet stringent clock synchronization service performance requirements, for example, those shown in the Table 1.

The range of uncertainty for the most demanding synchronization requirement for a single Uu interface is shown in Table 2 and was agreed at 3GPP TSG-RAN WG2 #113-e to meet performance requirements set forth in Table 1. The two scenarios in Table 2 represent a general wide area deployment and a local deployment area.

TABLE 2
Time synchronization error budget for single Uu interface

| Scenario | Single Uu interface Budget |
|---|---|
| Control-to-Control | ±145 ns to ±275 ns |
| Smart Grid | ±795 ns to ±845 ns |

In 3GPP Rel-15/Rel-16, the legacy uplink (UL) transmission timing adjustment (i.e., timing advanced) can be re-used to estimate and compensate the propagation delay. 3GPP Timing Advance (TA) command is utilized in cellular communication for uplink transmission synchronization and it is an implementation variant of a Round Trip Time (RTT) measurement. Theoretically, the dynamic part of the TA, i.e., N_{TA} is equal to twice the propagation delay, considering the same propagation delay value applies to both downlink (DL) and UL directions. Since the TA command is transmitted to the UE mainly via the Medium Access Control (MAC) control element (CE), the UE can derive the propagation delay. The challenges of the TA method are that due to various implementation inaccuracies in transmit timing and reception timing at gNB and UE. Specifically, the TA method introduces up-to 540 ns uncertainty to determine the downlink propagation delay on a single Uu interface based on Rel-15/Rel-16 implementation requirements. See, R1-1901470, Reply LS on TSN requirements evaluation, RAN1, 3GPP TSG-RAN WG1 Ad-Hoc Meeting 1901 Taipei, Taiwan, Jan. 21-25, 2019.

Thus, there is a need to introduce a new propagation delay compensation method to meet the most demanding synchronization requirement in Rel-17. The Rel-17 Radio Access Network (RAN) work item “Enhanced Industrial Internet of Things (IoT) and ultra-reliable and low latency communication (URLLC) support for NR” has the following objective related with propagation delay compensation:

Enhancements for support of time synchronization:
a. RAN impacts of SA2 work on uplink time synchronization for TSN, if any. [RAN2]
b. Propagation delay compensation enhancements (including mobility issues, if any). [RAN2, RAN1, RAN3, RAN4]

One potential method is to enhance the TA-based method with finer granularity TA commands and requirements. Another potential method is to leverage the legacy multi-RTT positioning method. This legacy method makes use of, for example, the UE Receiver-Transmitter (Rx-Tx) time difference measurements and Downlink-Positioning Reference Signal-Reference Signal Received Power (DL-PRS-RSRP) of DL signals received from multiple Transmission Reception Points (TRPs) measured by the UE, and the measured gNB Rx-Tx time difference measurements and Uplink-Sounding Reference Signal-Reference Signal Received Power (UL-SRS-RSRP) at multiple TRPs of uplink signals transmitted from the UE. The measurements are used to determine the RTT at the positioning server which are used to estimate the location of the UE.

The new RTT based delay compensation method leverages the legacy multi-RTT positioning method and is illustrated in FIG. 2. Specifically, as illustrated, the UE transmits an UL frame i and records the transmission time as t₁. The gNB receives UL frame i and records the time of arrival of the first detected path as t₃. The gNB transmits a DL frame j to the UE, and records transmission time as t₂. The UE receives DL frame j and records the time of arrival of the first detected path as t₄. The following calculations are then performed in the UE and gNB, respectively:

$${UE}_{Rx - Tx} diff = {t}_{4 -} {t}_{1} \qquad i )$$

$${gNB}_{Rx - Tx} diff = {t}_{3 -} {t}_{2} . \qquad ii )$$

The latter quantity can be positive or negative depending on the whether gNB transmits the DL frame before or after receiving the UL frame. RTT can be then calculated as follows:

$$RTT = ( gNB Rx - Tx time difference ) + ( UE Rx - Tx time difference )$$

The propagation delay is one half of the RTT.

There are two variants of the RTT based delay compensation method, depending on which node calculates the RTT in response to the other node delivering its Rx-TX difference. For example, according to UE-side propagation delay compensation, the gNB delivers the gNB Rx-Tx time difference to the UE, and then the UE calculates the round-trip time RTT to obtain the propagation delay. Conversely, according to gNB-side propagation delay compensation, the UE delivers the UE Rx-Tx time difference to the gNB, and then the gNB calculates the round-trip time RTT to obtain the propagation delay.

Synchronization Signal and PBCH block

FIG. 3 illustrates the time-frequency structure of a Synchronization Signal Block (SSB). Specifically, the SSB, which may also be referred to as a Synchronization Signal and PBCH (SS/PBCH) block consists of primary synchronization signals (PSS) and secondary synchronization signals (SSS), each occupying 1 symbol and 127 subcarriers. PBCH spans across 3 OFDM symbols and 240 subcarriers, but an unused part occupies one symbol in the middle for SSS

The possible time locations of SSBs within a half-frame are determined by sub-carrier spacing, and the periodicity of the half-frames where SSBs are transmitted is configured by the network. During a half-frame, different SSBs may be transmitted in different spatial directions such as, for example, using different beams that span the coverage area of a cell. The candidate SS/PBCH blocks in a half frame are indexed in an ascending order in time from 0 to L̅ₘₐₓ −1, where L̅ₘₐₓ is determined according to SS/PBCH block patterns. Lₘₐₓ is a maximum number of SS/PBCH block indexes in a cell, and the maximum number of transmitted SS/PBCH blocks within a half frame is Lₘₐₓ. For operation without shared spectrum channel access, Lₘₐₓ=L̅ₘₐₓ

Within the frequency span of a carrier, multiple SSBs can be transmitted. The PCIs of SSBs transmitted in different frequency locations do not have to be unique. Thus, different SSBs in the frequency domain can have different PCIs. However, when an SSB is associated with an Remaining Minimum System Information (RMSI), the SSB is referred to as a Cell-Defining SSB (CD-SSB). A PCell is always associated to a CD-SSB located on the synchronization raster.

Polar coding is used for PBCH. PBCH symbols carry its own frequency-multiplexed Demodulation Reference Signal (DMRS). Quadrature Phase Shift Keying (QPSK) modulation is used for PBCH. The PBCH physical layer model is described in 3GPP TS 38.202 v. 17.2.0.

### Quasi Co-Location

In New Radio (NR), several signals can be transmitted from the same base station antenna from different antenna ports. These signals can have the same large-scale properties, for instance in terms of Doppler shift/spread, average delay spread, or average delay. These antenna ports are then said to be quasi co-located (QCL).

The network can then signal to the UE that two antenna ports are QCL. If the UE knows that two antenna ports are QCL with respect to a certain parameter (e.g., Doppler spread), the UE can estimate that parameter based on one of the antenna ports and use that estimate when receiving the other antenna port. Typically, the first antenna port is represented by a measurement reference signal such as Channel State Information-Reference Signal (CSI-RS) (known as source RS), and the second antenna port is a Demodulation Reference Signal (DMRS) (known as target RS).

For instance, if antenna ports A and B are QCL with respect to average delay, the UE can estimate the average delay from the signal received from antenna port A (known as the source reference signal (RS)) and assume that the signal received from antenna port B (target RS) has the same average delay. This is useful for demodulation since the UE can know beforehand the properties of the channel when trying to measure the channel utilizing the DMRS.

Information about what assumptions can be made regarding QCL is signalled to the UE from the network. In NR, four types of QCL relations between a transmitted source Reference Signal (RS) and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced to facilitate beam management with analog beamforming and is known as spatial QCL. There is currently no strict definition of spatial QCL, but the understanding is that if two transmitted antenna ports are spatially QCL, the UE can use the same Rx beam to receive them. Note that for beam management, the discussion mostly revolves around QCL Type D, but it is also necessary to convey a Type A QCL relation for the RSs to the UE, so that it can estimate all the relevant large scale parameters. In practice, spatial QCL between two different signals imply that they are transmitted from the same place and in the same beam.

Typically, this is achieved by configuring the UE with a CSI-RS for tracking, which is also known as a Tracking Reference Signal (TRS), for time/frequency offset estimation. To be able to use any QCL reference, the UE would have to receive it with a sufficiently good Signal to Interference and Noise Ratio (SINR). In many cases, this means that the TRS has to be transmitted in a suitable beam to a certain UE. It may be noted that in 3GPP specifications TRS is defined as a special kind of Non-Zero Power (NZP) CSI-RS with a higher layer parameter ‘trs-Info’ configured.

To introduce dynamics in beam and transmission point (TRP) selection, the UE can be configured through RRC signalling with N Transmission Configuration Indication (TCI) states, where Nis up to 128 in frequency range 2 (FR2) and up to 8 in frequency range 1 (FR1), depending on UE capability.

Each TCI state contains QCL information, i.e., one or two source DL RSs, each source RS associated with a QCL type. For example, a TCI state contains a pair of reference signals, each associated with a QCL type, e.g., two different CSI-RSs {CSI-RS1, CSI-RS2} is configured in the TCI state as {qcl-Type1, qcl-Type2}={Type A, Type D}. It means the UE can derive Doppler shift, Doppler spread, average delay, delay spread from CSI-RS1 and Spatial Rx parameter (i.e., the RX beam to use) from CSI-RS2. In case type D (spatial information) is not applicable, such as low- or mid-band operation, then a TCI state contains only a single source RS.

Each of the N states in the list of TCI states can be interpreted as a list of N possible beams transmitted from the network or a list of N possible TRPs used by the network to communicate with the UE.

A first list of available TCI states is configured for Physical Downlink Shared Channel (PDSCH), and a second list for Physical Downlink Control Channel (PDCCH) contains pointers, known as TCI State identifiers (IDs), to a subset of the TCI states configured for PDSCH. The network then activates one TCI state for PDCCH (i.e., provides a TCI for PDCCH) and up to eight active TCI states for PDSCH. The number of active TCI states the UE support is a UE capability, but the maximum is eight.

Each configured TCI state contains parameters for the quasi co-location associations between source reference signals (CSI-RS or SS/PBCH) and target reference signals (e.g., PDSCH/PDCCH DMRS ports). TCI states are also used to convey QCL information for the reception of CSI-RS.

Assume a UE is configured with four active TCI states (from a list of totally sixty-four configured TCI states). Hence, sixty TCI states are inactive, and the UE does not need to be prepared to have large scale parameters estimated for those. But, the UE continuously tracks and updates the large scale parameters for the four active TCI states by measurements and analysis of the source RSs indicated by each TCI state.

When scheduling a PDSCH to a UE, the Downlink Control Information (DCI) contains a pointer to one active TCI. The UE then knows which large scale parameter estimate to use when performing PDSCH DMRS channel estimation and thus PDSCH demodulation.

### Spatial Relation Definition

While QCL Type D refers to a relationship between two different DL RSs from a UE perspective, NR has also adopted the term “spatial relation” to refer to a relationship between an UL RS (PUCCH/PUSCH DMRS/SRS) and another RS, which can be either a DL RS (CSI-RS or SSB) or an UL RS (SRS). This is also defined from a UE perspective. If the UL RS is spatially related to a DL RS, it means that the UE should transmit the UL RS in the opposite (reciprocal) direction from which it previously received the second RS. More precisely, the UE should apply the “same” Transmitter (Tx) spatial filtering configuration for the transmission of the first RS as the Receiver (Rx) spatial filtering configuration it used to previously receive the second RS. If the second RS is an UL RS, then the UE should apply the same Tx spatial filtering configuration for the transmission of the first RS as the Tx spatial filtering configuration it used to previously transmit the second RS.

There currently exist certain challenge(s), however. For example, in NR, the gNB encapsulates the 5GS clock information in the ReferenceTimelnfo information element and transmits it to the UEs in the cell. This ReferenceTime may be denoted as T_{ref} or ReferenceTime T_{ref}.

For a gNB with single TRP, ReferenceTime T_{ref} provides clock information associated with the single TRP. However, for a gNB with multiple TRPs, each TRP is likely to be located at different distances from the baseband, and there exists non-negligible delay on the backhaul links between the different TRPs and the baseband unit. The local time at each TRP varies slightly. Thus, it is not clear which TRP the ReferenceTime T_{ref} should be associated with and so the time synchronization target on the Uu interface cannot be met.

### SUMMARY

Certain aspects of the disclosure and their embodiments may provide solutions to these or other challenges. For example, methods and systems are provided to resolve the ReferenceTime T_{ref} ambiguity for a gNB that has multiple TRPs with different IDs but that are associated with the same physical cell ID.

According to certain embodiments, a method for time synchronization by a wireless device includes receiving time information from a network node. The time information includes at least one reference time value for time synchronization and an indication of at least one TRP associated with the time information.

According to certain embodiments, a wireless device for time synchronization is configured to receive time information from a network node. The time information includes at least one reference time value for time synchronization and an indication of at least one TRP associated with the time information.

According to certain embodiments, a method for provisioning of reference time for time synchronization by a network node includes transmitting time information to at least one wireless device. The time information includes at least one reference time value for time synchronization and an indication of at least one transmission/reception point, TRP, associated with the time information.

According to certain embodiments, a network node for provisioning of reference time for time synchronization is configured to transmit time information to at least one wireless device. The time information includes at least one reference time value for time synchronization and an indication of at least one transmission/reception point, TRP, associated with the time information.

Certain embodiments may provide one or more of the following technical advantage(s). For example, certain embodiments may provide a technical advantage of resolving the ReferenceTime T_{ref} ambiguity for a gNB that has multiple TRPs with different IDs and that are associated with the same physical cell ID.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates gNB SFN Transmissions;

FIG. 2 illustrates an example RTT based delay compensation method;

FIG. 3 illustrates the time-frequency structure of a SSB;

FIG. 4 illustrates a single reference time value T_{ref} being sent by the gNB, according to certain embodiments;

FIG. 5 illustrates an example where each TRP has its own reference time value;

FIG. 6 illustrates another example where each TRP has its own reference time value;

FIG. 7 illustrates an example communication system, according to certain embodiments;

FIG. 8 illustrates an example UE, according to certain embodiments;

FIG. 9 illustrates an example network node, according to certain embodiments;

FIG. 10 illustrates a block diagram of a host, according to certain embodiments;

FIG. 11 illustrates a virtualization environment in which functions implemented by some embodiments may be virtualized, according to certain embodiments;

FIG. 12 illustrates a host communicating via a network node with a UE over a partially wireless connection, according to certain embodiments;

FIG. 13 illustrates a method by a wireless device for time synchronization, according to certain embodiments;

FIG. 14 illustrates a method by a network node for provisioning of reference time for time synchronization, according to certain embodiments; and

FIG. 15 illustrates TSN E2E timing delivery case 2 with ingress at the UE, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

Herein, the term Transmission Reception Point (TRP) is used, though the term may or may not be used in 3GPP specification descriptions. Other terminologies can be analogously used instead such as, for example, transmission point (TP), antenna array, remote radio heads (RRH), remote antenna of a base station, etc. The TRP may be identified or indicated by one or more of the following identifiers: TRP ID, TP ID, the TCI state and/or a spatial relation associated with the TRP, the associated SSB index, the associated reference signal (e.g., TRS, PRS) index, etc. It is also possible that a TRP is represented by a group of TCI states, a group of spatial relations, and/or a group of SSB indices. Each such group may be alternatively or additionally identified by a ID which may be higher layer configured by the gNB. The higher layer configured ID can be cell-specific where a shared ID is provided to all UEs in the cell, or the higher layer configured ID can be UE-specific where a different ID is provided to each UE.

According to certain embodiments, when providing the reference time information, the network indicates to which TRP (e.g., a SSB index or a group of SSB indices) the reference time information is referenced.

According to certain embodiments, the network additionally or alternatively indicates one or more such indications on a per TRP basis. For example, each TRP may be identified by a SSB index or a group of SSB indices, and different reference time information may be indicated per TRP. For example, each reference time information may be associated with a SSB index or a group of SSB indices.

According to certain embodiments, upon receiving such an indication, the wireless device, which may include a UE, uses the indicated TRP (e.g., each TRP is identified by a SSB index or a group of SSB indices) to track the boundary of the SFN to derive the delivered reference time information, while the UE may use another TRP (e.g., each TRP is identified by a SSB index or a group of SSB indices) to track the boundary of the SFN for data transmission.

A Single Reference Time Value Sent from Primary TRP

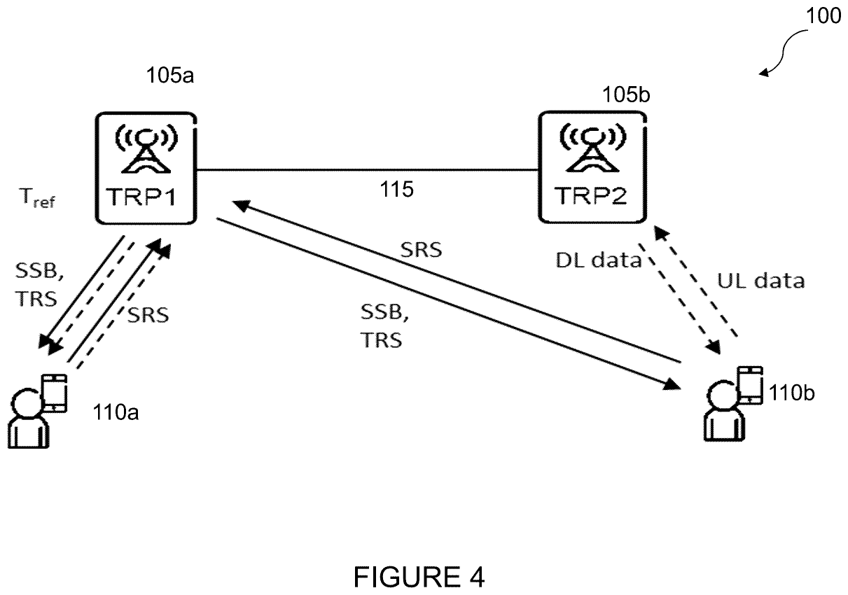

FIG. 4 illustrates example signalling 100 where a single reference time value T_{ref} that indicates the clock time at a primary TRP 105a is sent to all UEs 110 in a cell, according to certain embodiments. Each UE 110 in the cell estimates the propagation delay Tₚ between the primary TRP 105a and the given UE 110. The clock time at the UE 110 is then obtained by combining T_{ref} and Tₚ as follows: T_{ref}+Tₚ.

Specifically, in FIG. 4, TRP1 105a is identified as the primary TRP, and TRP2 105b is identified as a secondary TRP. TRP2 105b is connected to TRP1 105a via a backhaul link 115. For time synchronization purposes, both UEs 110a and 110b receive the same reference time value T_{ref}. For both UEs 110a and 110b, the propagation delay is estimated between the primary TRP 105a and the concerned UE 110. In FIG. 4, it is illustrated that UE 110b maintains UL and DL data communication with the secondary TRP 105b, but estimates the propagation delay between primary TRP 105a and UE 110b. In this example, the propagation delay between TRP1 105a and UE 110b is estimated using DL reference signal TRS and UL reference signal SRS associated with the primary TRP 105a. UE 110b also receives SSB associated with the primary TRP 105a, where the SSB index may be used to identify the TRP 105a, and the SSB is used as QCL RS for the TRS.
For UE 110a, the estimated clock time is T_{UEa}=T_{ref}+T_{p,a}, where T_{p,a} denotes the estimated propagation delay between the primary TRP 105a and UE 110a.
For UE 110b, the estimated clock time is T_{UEb}=T_{ref}+T_{p,b}, where T_{p,b} denotes the estimated propagation delay between the primary TRP 105a and UE 110b.

While a single secondary TRP 110b is illustrated in FIG. 4, it is recognized that there can be multiple secondary TRPs 110 sharing the same physical cell ID in a cell.

While the reference time value T_{ref} indicates the clock time at the primary TRP 105a, the RRC message carrying T_{ref} may be carried by a PDSCH which is transmitted by the primary TRP 105a, or by the secondary TRP 105b, or jointly by two TRPs.

According to certain embodiments, it is up to network implementation to designate the TRPs in the cell as primary TRP(s) and secondary TRP(s). Many factors may affect the selection of TRP as primary TRP, for example:
Geographic locations of the TRPs: For instance, a TRP located (approximately) in the center of the cell is a good candidate as primary TRP.
Cost of maintaining a TRP with very high clock accuracy: For instance, due to the high cost, only one TRP in the cell is equipped with the capability to maintain very high timing accuracy which is then designated as primary TRP, while other TRPs are allowed to be less capable with timing accuracy.
Access to an external time reference like GPS: For instance, TRP(s) equipped with GPS receiver and located for good GPS signal reception are candidate(s) as primary TRP, while other TRPs do not need to satisfy the requirement of GPS reception (e.g., no GPS receiver, located indoors, etc.).

In a particular embodiment, one TRP is designated as the primary TRP, and one or more TRPs are designated as secondary TRPs. The secondary TRP(s) is/are different from the primary TRP. In another particular embodiment, the designation of primary TRP(s) and secondary TRP(s) is cell specific such that the same designation is shared by all UEs in the cell. In another particular embodiment, the designation of primary TRP(s) and secondary TRP(s) is UE specific such that different UE may be assigned a different TRP as primary, and similarly for secondary TRP. In a particular embodiment, the primary TRP is co-located with the full protocol stack including Packet Data Convergence Protocol (PDCP)/Radio Link Control (RLC)/MAC. In another variation, the primary TRP is a TRP dedicated to time synchronization such that the primary TRP does not need to support data communication.

### Each TRP has its own Reference Time Value

According to certain other embodiments, for two or more TRPs used for time synchronization, each TRP has its own reference time value. Thus, it is not necessary to differentiate TRPs as primary TRP and secondary TRP. All TRPs used for time synchronization can be treated the same, from the perspective of time synchronization.

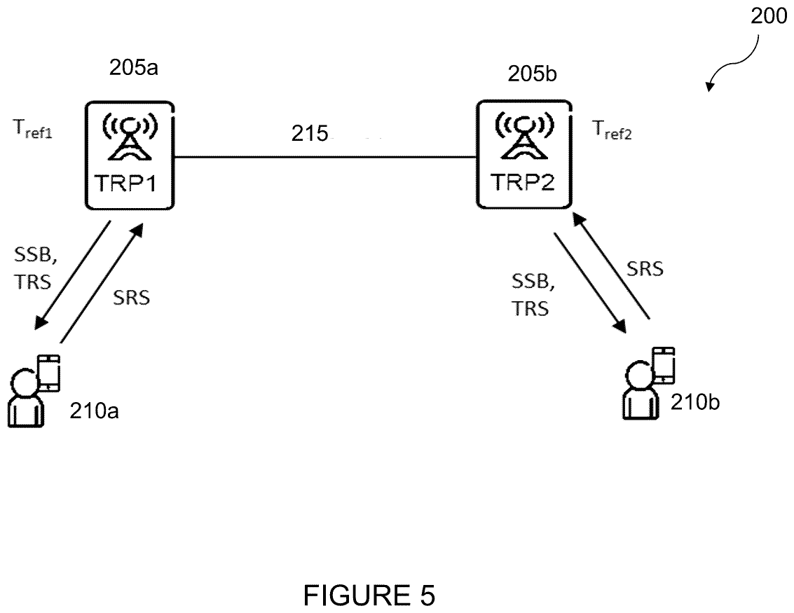

FIG. 5 illustrates example signalling 200 where each TRP in a cell has its own reference time value, according to certain embodiments. For example, in FIG. 5, TRP1 105a and TRP2 105b each has T_{ref1} and T_{ref2}, respectively. Each UE 210 receives the reference time from the TRP to which the UE is connected, and each UE 210 estimates propagation delay from the connected TRP. TRP2 205b is connected to TRP1 205a via a backhaul link 215. UE 210a prefers to connect to TRP1 205a, while UE 210b prefers to connect to TRP2 205b.Specifically, UE 210a receives clock time T_{ref1} associated with TRP1 205a. The propagation delay between the TRP1 205a and UE 210a is estimated as Tₚ,a. Then the estimated clock time at UE 210a is T_{UEa}=T_{ref1}+T_{p,a}. UE 210b receives clock time T_{ref2} associated with TRP2 205b. The propagation delay between the TRP2 205b and UE 210b is estimated as T_{p,b}. Then the estimated clock time at UEb 1S T_{UEb}=T_{ref}2+T_{p,b}.

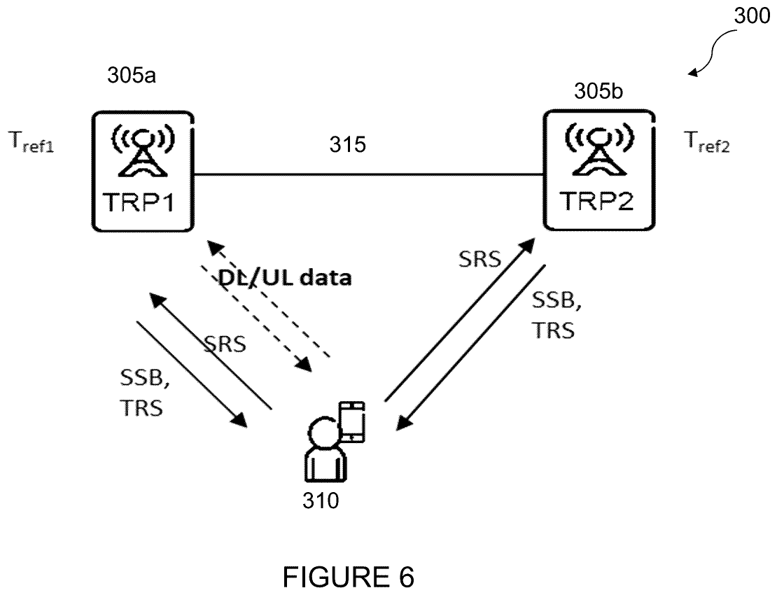

FIG. 6 illustrates example signalling 300 where each TRP 305 has its own reference time value and connects to each UE 310, according to certain embodiments. Specifically, as illustrated in FIG. 6, TRP1 305a has its clock time T_{ref1}, TRP2 305b has its clock time T_{ref2}. TRP2 305b is connected to TRP1 305a via a backhaul link 315. UE 310 connects to both TRP1 305a and TRP2 305b for time synchronization. For example, UE 310 receives clock time T_{ref1}associated with TRP1 305a. The propagation delay between the TRP1 305a and UE 310 is estimated as T_{p,a1}. Then, the estimated clock time at UE 310 is T_{UEa1}=T_{ref1}+T_{p,a1}. Additionally, UE 3310 receives clock time T_{ref2} associated with TRP2 305b. The propagation delay between the TRP2 305b and UE 310 is estimated as T_{p,a2}. Then the estimated clock time at UE 310 is T_{UEa2}=T_{ref2}+T_{p,a2}. Then the final estimated clock time at UE 310 takes into account of both T_{UEa1} and T_{UEa2}.

In a particular embodiment, the final propagation delay is estimated as T_{UEa,final}=min(T_{UEa1}, T_{UEa2}).

In a particular embodiment, the final propagation delay is estimated as T_{UEa,final} =mean(T_{UEa1}, T_{UEa2}). That is, taking the average value among the TRPs.

In a particular embodiment, the final propagation delay is estimated by selecting the latest available value among T_{UEa1} and T_{UEa2}, whichever has the most fresh measurement.

In a particular embodiment, the final propagation delay is estimated by a weighted average, as T_{UEa,final}=alpha*T_{UEa1}+(1-alpha)*T_{UEa2}, where 0<alpha <1. In one method, alpha is a value calculated based on the RS signal strengths. For example, if the RS associated with TRP1 have higher RSRP/RSRQ than previously, then alpha would increase too.

According to various embodiments, transmission/reception/measurement/report for time synchronization purposes may or may not be performed independent of those for data those for data communication purpose. As illustrated in FIG. 6, the UE 310 has DL and UL radio links to TRP1 305a for data communication, while maintaining DL and UL radio links to both TRP1 305a and TRP2 305b for time synchronization purposes.

While the reference time value T_{ref1} and T_{ref2} indicate the clock time at TRP1 305a and TRP2 305b, respectively, the RRC messages carrying T_{ref1} and T_{ref2} can be transmitted in many ways. For instance, the RRC message carrying T_{ref1} may be transmitted by TRP1 305a, and the RRC message carrying T_{ref2} may be transmitted by TRP2 305b, in a particular embodiment. In another example, the RRC message(s) carrying T_{ref1} and T_{ref2} may be jointly transmitted by TRP1 305a and TRP2 305b. In yet another example embodiment, the RRC message carrying T_{ref1} may be transmitted by TRP1 305a, and the RRC message carrying T_{ref2} may be jointly transmitted by TRP1 305a and TRP2 305b.

Communicating Each TRP's Individual Reference Time Value Between gNB-DU and gNB-CU

According to certain embodiments, since each TRP has its individual reference time value, for reporting reference time info from gNB-DU to gNB-CU, the reference time is reported for each TRP separately.

For example, the “Time Reference Information” IE for F1AP can be extended to include the TRP ID, in a particular embodiment. Additionally, a list of Time Reference Info is to be sent, with each item in the list provide information for one TRP.

| | | | IE type and | |
|---|---|---|---|---|
| IE/Group Name | Presence | Range | reference | Semantics description |
| Time Reference | | | | |
| Information List | | | | |
| > Time Reference | | 1 . . . | | |
| Information List Item | | <maxnoofTRPs> | | |
| >> Reference Time | M | | 9.3.1.149 | |
| >> Reference SFN | M | | INTEGER (0 . . . 1023) | |
| >> Uncertainty | O | | INTEGER (0 . . . 32767, | This field indicates the |
| | | | . . .) | uncertainty of the reference |
| | | | | time information provided in |
| | | | | ReferenceTimeInfo IE, refer to |
| | | | | 6.3.2 of TS 38.331 [8]. |
| >> Time Information | O | | ENUMERATED | |
| Type | | | (localClock) | |
| >> TRP ID | O | | INTEGER | TRP Identifier that identifies a |
| | | | (1 . . . 65535, . . .) | TRP within an gNB-CU |

Identifier of each TRP

At the radio protocol, there is a need to identify each TRP, so that the gNB and UE know which TRP the reference time is associated with.

In a particular embodiment, the SSB index is used to identify the TRP. Each TRP is associated with one or more SSB index, and the TRP transmits the SSB(s) associated with it.

For sending referenceTimeInfo from gNB to UE in a RRC message (broadcast or unicast), the referenceTimelnfo is sent together with the associated SSB index, in a particular embodiment. The SSB index (or equivalently, SSB Position in Burst) provides information to indicate the TRP ID whose clock time is provided by the reference TimeInfo.

When UE receives the referenceTimelnfo from gNB, the UE can know which SSB index the UE should use to detect the SFN boundary.

In one implementation example, a new field, ssb, that indicates the SSB index is added in the RRC IE referenceTimelnfo-rxx, as shown below.

ReferenceTimeInfo-rxx ::= SEQUENCE {

| time-r16 | ReferenceTime-r16, | |
|---|---|---|
| uncertainty-r16 | INTEGER (0..32767) | OPTIONAL, - |

- Need S

| | | |
|---|---|---|
| timeInfoType-r16 | ENUMERATED {localClock} | OPTIONAL, - |

- Need S

| | | |
|---|---|---|
| referenceSFN-r16 | INTEGER (0..1023) | OPTIONAL - |

- Cond RefTime

| | |
|---|---|
| ssb | SSB-Index |

}

In another example embodiment, the network transmits in a RRC message multiple instances of reference time information in which each instance contains an SSB index. An example is provided below:

ReferenceTimeInfoPerTRPList-rxx ::= SEQUENCE (SIZE
(1..maxNrofRefTimePerCell-r17)) OF ReferenceTimeInfoPerTRP
ReferenceTimeInfo-r17 ::= SEQUENCE {

| time-r16 | ReferenceTime-r16, | |
|---|---|---|
| uncertainty-r16 | INTEGER (0..32767) | OPTIONAL, -- |

Need S

| | | |
|---|---|---|
| timeInfoType-r16 | ENUMERATED {localClock} | OPTIONAL, -- |

Need S

| | | |
|---|---|---|
| referenceSFN-r16 | INTEGER (0..1023) | OPTIONAL -- |

Cond RefTime
referenceTimeInforPerTRPList-rxxx
ReferenceTimeInfoPerTRPList-rxx OPTIONAL
}

| | |
|---|---|
| ReferenceTimeInfoPerTRP ::= | SEQUENCE { |
| refTenNanoSeconds-r16 | INTEGER (0..99999) |
| ssb | SSB-Index |

}

According to certain embodiments, the network does not need to send each copy of referenceTimeInfo, but only the delta difference. In a particular embodiment, for example, the network sends the refTenNanoSeconds-r16 in the ReferenceTimeInfoPerTRP.

The SSB index is also used to indicate the SSB that should be used as the reference RS for the DL RS (e.g., TRS or PRS) of time synchronization for the purpose of QCL.

In another embodiment, multiple SSBs may be transmitted from a single TRP. For example, each SSB from a TRP may be transmitted in different spatial directions. For instance, TRP #1 may transmit a first set of SSBs and TRP #2 may transmit a second set of SSBs. In this embodiment, a UE may be configured (e.g., via a RRC message) with a first group ID for the first set of SSBs and a second group ID for the second set of SSBs. Thus, in this embodiment, the SSB group ID is used to identify the TRP. That is, each TRP is associated with the SSB indices that belong to the associated SSB group ID.

Furthermore, for sending referenceTimelnfo from the gNB to the UE in a RRC message (broadcast or unicast), the referenceTimelnfo is sent together with the associated SSB group ID. The SSB group ID provides information to indicate the TRP ID whose clock time is provided by the referenceTimeInfo. In one implementation example, a new field ssbGroupId that indicates the SSB group ID associated with the referenceTimeInfo is added in the RRC IE referenceTimelnfo-rxx, see below. Although, the following example shows the SSB group ID with range 0 to 3 as an illustration, in general the range can be other index values.

ReferenceTimeInfo-rxx ::= SEQUENCE {

| time-r16 | ReferenceTime-r16, | |
|---|---|---|
| uncertainty-r16 | INTEGER (0..32767) | OPTIONAL, - |

- Need S

| | | |
|---|---|---|
| timeInfoType-r16 | ENUMERATED {localClock} | OPTIONAL, - |

- Need S

| | | |
|---|---|---|
| referenceSFN-r16 | INTEGER (0..1023) | OPTIONAL - |

- Cond RefTime

| | |
|---|---|
| ssbGroupId | INTEGER (0...3) |

}

In another example embodiment, the network transmits in a RRC message multiple instances of reference time information in which each instance contains an SSB group ID. An example is provided below:

ReferenceTimeInfoPerTRPList-rxx ::= SEQUENCE (SIZE
(1..maxNrofRefTimePerCell-r17)) OF ReferenceTimeInfoPerTRP
ReferenceTimeInfo-r17 ::= SEQUENCE {

| time-r16 | ReferenceTime-r16, | |
|---|---|---|
| uncertainty-r16 | INTEGER (0..32767) | OPTIONAL, -- |

Need S

| | | |
|---|---|---|
| timeInfoType-r16 | ENUMERATED {localClock} | OPTIONAL, -- |

Need S

| | | |
|---|---|---|
| referenceSFN-r16 | INTEGER (0..1023) | OPTIONAL -- |

Cond RefTime
referenceTimeInforPerTRPList-rxxx
ReferenceTimeInfoPerTRPList-rxx OPTIONAL
}

| | |
|---|---|
| ReferenceTimeInfoPerTRP ::= | SEQUENCE { |
| refTenNanoSeconds-r16 | INTEGER (0..99999) |
| ssbGroupId | INTEGER (0...3) |

}

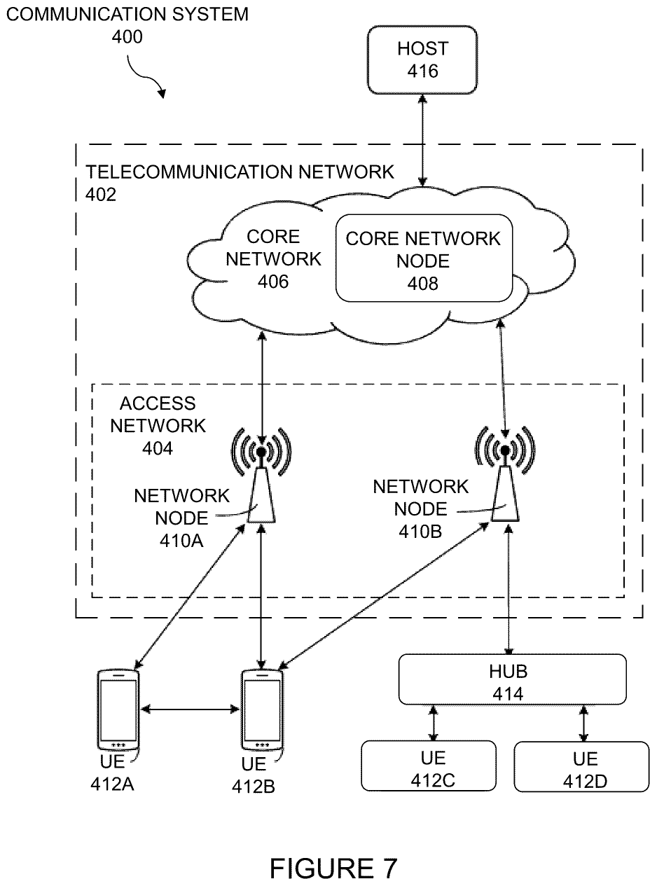

FIG. 7 shows an example of a communication system 400 in accordance with some embodiments. In the example, the communication system 400 includes a telecommunication network 402 that includes an access network 404, such as a radio access network (RAN), and a core network 406, which includes one or more core network nodes 408. The access network 404 includes one or more access network nodes, such as network nodes 410a and 410b (one or more of which may be generally referred to as network nodes 410), or any other similar 3^{rd} Generation Partnership Project (3GPP) access node or non-3GPP access point. The network nodes 410 facilitate direct or indirect connection of user equipment (UE), such as by connecting UEs 412a, 412b, 412c, and 412d (one or more of which may be generally referred to as UEs 412) to the core network 406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 400 may include any number of wired or wireless networks, network nodes, UEs, and/or any other components or systems that may facilitate or participate in the communication of data and/or signals whether via wired or wireless connections. The communication system 400 may include and/or interface with any type of communication, telecommunication, data, cellular, radio network, and/or other similar type of system.

The UEs 412 may be any of a wide variety of communication devices, including wireless devices arranged, configured, and/or operable to communicate wirelessly with the network nodes 410 and other communication devices. Similarly, the network nodes 410 are arranged, capable, configured, and/or operable to communicate directly or indirectly with the UEs 412 and/or with other network nodes or equipment in the telecommunication network 402 to enable and/or provide network access, such as wireless network access, and/or to perform other functions, such as administration in the telecommunication network 402.

In the depicted example, the core network 406 connects the network nodes 410 to one or more hosts, such as host 416. These connections may be direct or indirect via one or more intermediary networks or devices. In other examples, network nodes may be directly coupled to hosts. The core network 406 includes one more core network nodes (e.g., core network node 408) that are structured with hardware and software components. Features of these components may be substantially similar to those described with respect to the UEs, network nodes, and/or hosts, such that the descriptions thereof are generally applicable to the corresponding components of the core network node 408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 416 may be under the ownership or control of a service provider other than an operator or provider of the access network 404 and/or the telecommunication network 402, and may be operated by the service provider or on behalf of the service provider. The host 416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 400 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 402 is a cellular network that implements 3GPP standardized features. Accordingly, the telecommunications network 402 may support network slicing to provide different logical networks to different devices that are connected to the telecommunication network 402. For example, the telecommunications network 402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 412 are configured to transmit and/or receive information without direct human interaction. For instance, a UE may be designed to transmit information to the access network 404 on a predetermined schedule, when triggered by an internal or external event, or in response to requests from the access network 404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 414 communicates with the access network 404 to facilitate indirect communication between one or more UEs (e.g., UE 412c and/or 412d) and network nodes (e.g., network node 410b). In some examples, the hub 414 may be a controller, router, content source and analytics, or any of the other communication devices described herein regarding UEs. For example, the hub 414 may be a broadband router enabling access to the core network 406 for the UEs. As another example, the hub 414 may be a controller that sends commands or instructions to one or more actuators in the UEs. Commands or instructions may be received from the UEs, network nodes 410, or by executable code, script, process, or other instructions in the hub 414. As another example, the hub 414 may be a data collector that acts as temporary storage for UE data and, in some embodiments, may perform analysis or other processing of the data. As another example, the hub 414 may be a content source. For example, for a UE that is a VR headset, display, loudspeaker or other media delivery device, the hub 414 may retrieve VR assets, video, audio, or other media or data related to sensory information via a network node, which the hub 414 then provides to the UE either directly, after performing local processing, and/or after adding additional local content. In still another example, the hub 414 acts as a proxy server or orchestrator for the UEs, in particular in if one or more of the UEs are low energy IoT devices.

The hub 414 may have a constant/persistent or intermittent connection to the network node 410b. The hub 414 may also allow for a different communication scheme and/or schedule between the hub 414 and UEs (e.g., UE 412c and/or 412d), and between the hub 414 and the core network 406. In other examples, the hub 414 is connected to the core network 406 and/or one or more UEs via a wired connection. Moreover, the hub 414 may be configured to connect to an M2M service provider over the access network 404 and/or to another UE over a direct connection. In some scenarios, UEs may establish a wireless connection with the network nodes 410 while still connected via the hub 414 via a wired or wireless connection. In some embodiments, the hub 414 may be a dedicated hub—that is, a hub whose primary function is to route communications to/from the UEs from/to the network node 410b. In other embodiments, the hub 414 may be a non-dedicated hub—that is, a device which is capable of operating to route communications between the UEs and network node 410b, but which is additionally capable of operating as a communication start and/or end point for certain data channels.

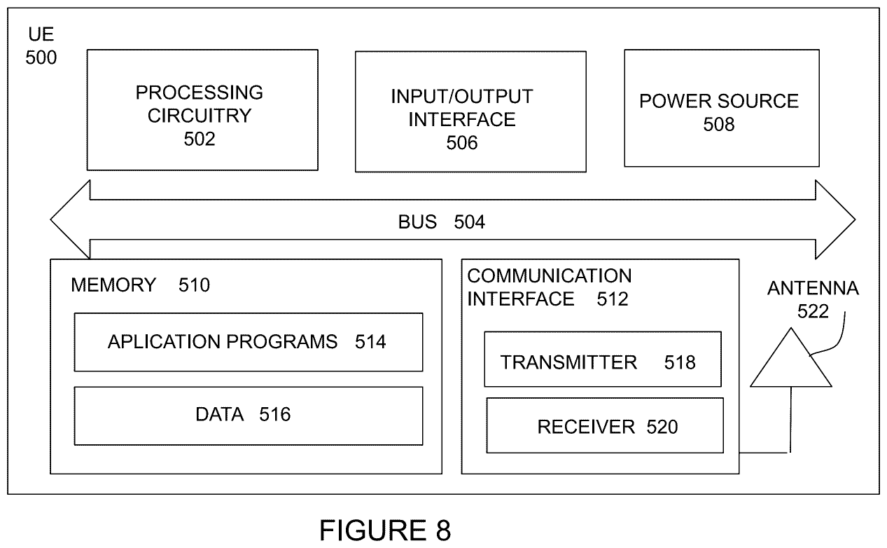

FIG. 8 shows a UE 500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 500 includes processing circuitry 502 that is operatively coupled via a bus 504 to an input/output interface 506, a power source 508, a memory 510, a communication interface 512, and/or any other component, or any combination thereof Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 502 is configured to process instructions and data and may be configured to implement any sequential state machine operative to execute instructions stored as machine-readable computer programs in the memory 510. The processing circuitry 502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 502 may include multiple central processing units (CPUs).

In the example, the input/output interface 506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 508 is structured as a battery or battery pack. Other types of power sources, such as an external power source (e.g., an electricity outlet), photovoltaic device, or power cell, may be used. The power source 508 may further include power circuitry for delivering power from the power source 508 itself, and/or an external power source, to the various parts of the UE 500 via input circuitry or an interface such as an electrical power cable. Delivering power may be, for example, for charging of the power source 508. Power circuitry may perform any formatting, converting, or other modification to the power from the power source 508 to make the power suitable for the respective components of the UE 500 to which power is supplied.

The memory 510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 510 includes one or more application programs 514, such as an operating system, web browser application, a widget, gadget engine, or other application, and corresponding data 516. The memory 510 may store, for use by the UE 500, any of a variety of various operating systems or combinations of operating systems.

The memory 510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 510 may allow the UE 500 to access instructions, application programs and the like, stored on transitory or non-transitory memory media, to off-load data, or to upload data. An article of manufacture, such as one utilizing a communication system may be tangibly embodied as or in the memory 510, which may be or comprise a device-readable storage medium.

The processing circuitry 502 may be configured to communicate with an access network or other network using the communication interface 512. The communication interface 512 may comprise one or more communication subsystems and may include or be communicatively coupled to an antenna 522. The communication interface 512 may include one or more transceivers used to communicate, such as by communicating with one or more remote transceivers of another device capable of wireless communication (e.g., another UE or a network node in an access network). Each transceiver may include a transmitter 518 and/or a receiver 520 appropriate to provide network communications (e.g., optical, electrical, frequency allocations, and so forth). Moreover, the transmitter 518 and receiver 520 may be coupled to one or more antennas (e.g., antenna 522) and may share circuit components, software or firmware, or alternatively be implemented separately.

In the illustrated embodiment, communication functions of the communication interface 512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 500 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

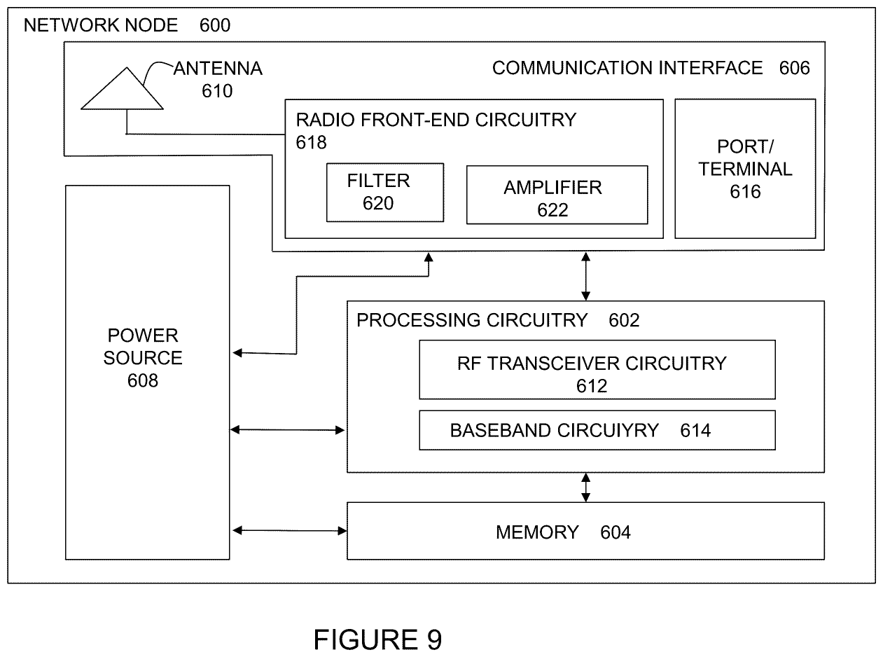

FIG. 9 shows a network node 600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 600 includes a processing circuitry 602, a memory 604, a communication interface 606, and a power source 608. The network node 600 may be composed of multiple physically separate components (e.g., a NodeB component and a RNC component, or a BTS component and a BSC component, etc.), which may each have their own respective components. In certain scenarios in which the network node 600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 600 may be configured to support multiple radio access technologies (RATs). In such embodiments, some components may be duplicated (e.g., separate memory 604 for different RATs) and some components may be reused (e.g., a same antenna 610 may be shared by different RATs). The network node 600 may also include multiple sets of the various illustrated components for different wireless technologies integrated into network node 600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 600.

The processing circuitry 602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 600 components, such as the memory 604, to provide network node 600 functionality.

In some embodiments, the processing circuitry 602 includes a system on a chip (SOC). In some embodiments, the processing circuitry 602 includes one or more of radio frequency (RF) transceiver circuitry 612 and baseband processing circuitry 614. In some embodiments, the radio frequency (RF) transceiver circuitry 612 and the baseband processing circuitry 614 may be on separate chips (or sets of chips), boards, or units, such as radio units and digital units. In alternative embodiments, part or all of RF transceiver circuitry 612 and baseband processing circuitry 614 may be on the same chip or set of chips, boards, or units.

The memory 604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 602. The memory 604 may store any suitable instructions, data, or information, including a computer program, software, an application including one or more of logic, rules, code, tables, and/or other instructions capable of being executed by the processing circuitry 602 and utilized by the network node 600. The memory 604 may be used to store any calculations made by the processing circuitry 602 and/or any data received via the communication interface 606. In some embodiments, the processing circuitry 602 and memory 604 is integrated.

The communication interface 606 is used in wired or wireless communication of signaling and/or data between a network node, access network, and/or UE. As illustrated, the communication interface 606 comprises port(s)/terminal(s) 616 to send and receive data, for example to and from a network over a wired connection. The communication interface 606 also includes radio front-end circuitry 618 that may be coupled to, or in certain embodiments a part of, the antenna 610. Radio front-end circuitry 618 comprises filters 620 and amplifiers 622. The radio front-end circuitry 618 may be connected to an antenna 610 and processing circuitry 602. The radio front-end circuitry may be configured to condition signals communicated between antenna 610 and processing circuitry 602. The radio front-end circuitry 618 may receive digital data that is to be sent out to other network nodes or UEs via a wireless connection. The radio front-end circuitry 618 may convert the digital data into a radio signal having the appropriate channel and bandwidth parameters using a combination of filters 620 and/or amplifiers 622. The radio signal may then be transmitted via the antenna 610. Similarly, when receiving data, the antenna 610 may collect radio signals which are then converted into digital data by the radio front-end circuitry 618. The digital data may be passed to the processing circuitry 602. In other embodiments, the communication interface may comprise different components and/or different combinations of components.

In certain alternative embodiments, the network node 600 does not include separate radio front-end circuitry 618, instead, the processing circuitry 602 includes radio front-end circuitry and is connected to the antenna 610. Similarly, in some embodiments, all or some of the RF transceiver circuitry 612 is part of the communication interface 606. In still other embodiments, the communication interface 606 includes one or more ports or terminals 616, the radio front-end circuitry 618, and the RF transceiver circuitry 612, as part of a radio unit (not shown), and the communication interface 606 communicates with the baseband processing circuitry 614, which is part of a digital unit (not shown).

The antenna 610 may include one or more antennas, or antenna arrays, configured to send and/or receive wireless signals. The antenna 610 may be coupled to the radio front-end circuitry 618 and may be any type of antenna capable of transmitting and receiving data and/or signals wirelessly. In certain embodiments, the antenna 610 is separate from the network node 600 and connectable to the network node 600 through an interface or port.

The antenna 610, communication interface 606, and/or the processing circuitry 602 may be configured to perform any receiving operations and/or certain obtaining operations described herein as being performed by the network node. Any information, data and/or signals may be received from a UE, another network node and/or any other network equipment. Similarly, the antenna 610, the communication interface 606, and/or the processing circuitry 602 may be configured to perform any transmitting operations described herein as being performed by the network node. Any information, data and/or signals may be transmitted to a UE, another network node and/or any other network equipment.

The power source 608 provides power to the various components of network node 600 in a form suitable for the respective components (e.g., at a voltage and current level needed for each respective component). The power source 608 may further comprise, or be coupled to, power management circuitry to supply the components of the network node 600 with power for performing the functionality described herein. For example, the network node 600 may be connectable to an external power source (e.g., the power grid, an electricity outlet) via an input circuitry or interface such as an electrical cable, whereby the external power source supplies power to power circuitry of the power source 608. As a further example, the power source 608 may comprise a source of power in the form of a battery or battery pack which is connected to, or integrated in, power circuitry. The battery may provide backup power should the external power source fail.

Embodiments of the network node 600 may include additional components beyond those shown in FIG. 9 for providing certain aspects of the network node's functionality, including any of the functionality described herein and/or any functionality necessary to support the subject matter described herein. For example, the network node 600 may include user interface equipment to allow input of information into the network node 600 and to allow output of information from the network node 600. This may allow a user to perform diagnostic, maintenance, repair, and other administrative functions for the network node 600.

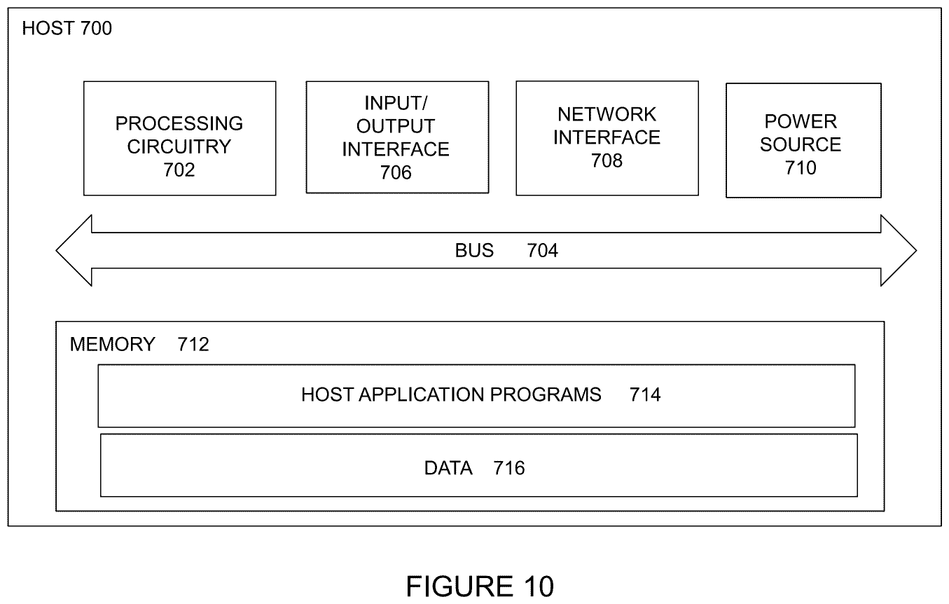

FIG. 10 is a block diagram of a host 700, which may be an embodiment of the host 416 of FIG. 7, in accordance with various aspects described herein. As used herein, the host 700 may be or comprise various combinations hardware and/or software, including a standalone server, a blade server, a cloud-implemented server, a distributed server, a virtual machine, container, or processing resources in a server farm. The host 700 may provide one or more services to one or more UEs.

The host 700 includes processing circuitry 702 that is operatively coupled via a bus 704 to an input/output interface 706, a network interface 708, a power source 710, and a memory 712. Other components may be included in other embodiments. Features of these components may be substantially similar to those described with respect to the devices of previous figures, such as FIGS. 5 and 6, such that the descriptions thereof are generally applicable to the corresponding components of host 700.

The memory 712 may include one or more computer programs including one or more host application programs 714 and data 716, which may include user data, e.g., data generated by a UE for the host 700 or data generated by the host 700 for a UE. Embodiments of the host 700 may utilize only a subset or all of the components shown. The host application programs 714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 714 may also provide for user authentication and licensing checks and may periodically report health, routes, and content availability to a central node, such as a device in or on the edge of a core network. Accordingly, the host 700 may select and/or indicate a different host for over-the-top services for a UE. The host application programs 714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

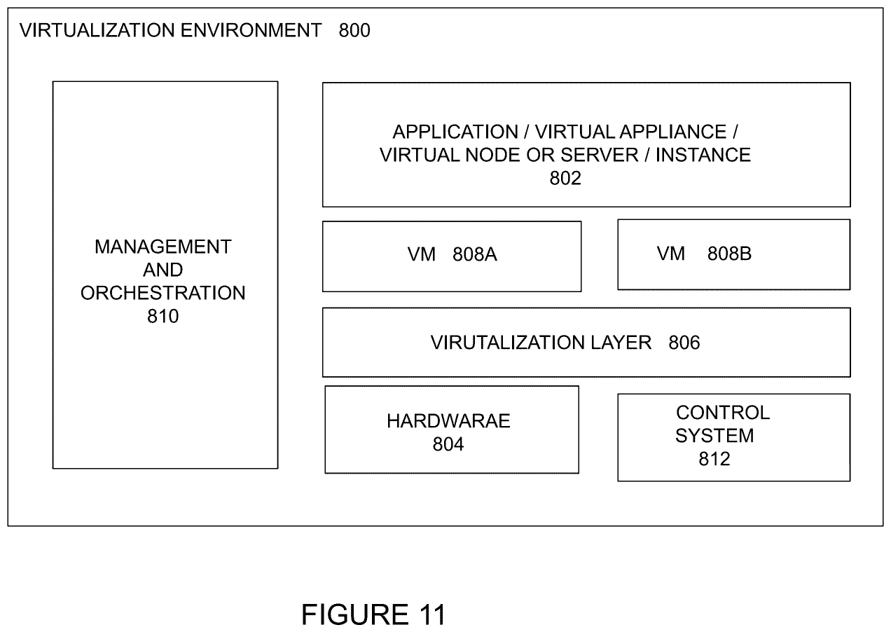

FIG. 11 is a block diagram illustrating a virtualization environment 800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 806 (also referred to as hypervisors or virtual machine monitors (VMMs)), provide VMs 808a and 808b (one or more of which may be generally referred to as VMs 808), and/or perform any of the functions, features and/or benefits described in relation with some embodiments described herein. The virtualization layer 806 may present a virtual operating platform that appears like networking hardware to the VMs 808.

The VMs 808 comprise virtual processing, virtual memory, virtual networking or interface and virtual storage, and may be run by a corresponding virtualization layer 806. Different embodiments of the instance of a virtual appliance 802 may be implemented on one or more of VMs 808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 808 may be a software implementation of a physical machine that runs programs as if they were executing on a physical, non-virtualized machine. Each of the VMs 808, and that part of hardware 804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 808 on top of the hardware 804 and corresponds to the application 802.

Hardware 804 may be implemented in a standalone network node with generic or specific components. Hardware 804 may implement some functions via virtualization. Alternatively, hardware 804 may be part of a larger cluster of hardware (e.g. such as in a data center or CPE) where many hardware nodes work together and are managed via management and orchestration 810, which, among others, oversees lifecycle management of applications 802. In some embodiments, hardware 804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 812 which may alternatively be used for communication between hardware nodes and radio units.

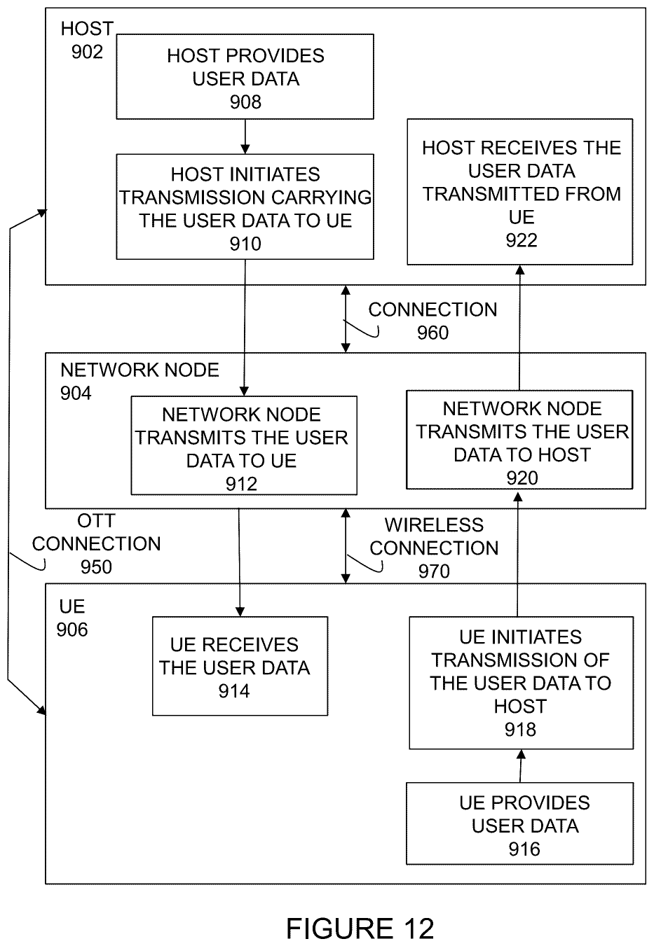

FIG. 12 shows a communication diagram of a host 902 communicating via a network node 904 with a UE 906 over a partially wireless connection in accordance with some embodiments.

Example implementations, in accordance with various embodiments, of the UE (such as a UE 412a of FIG. 7 and/or UE 500 of FIG. 8), network node (such as network node 410a of FIG. 7 and/or network node 600 of FIG. 9), and host (such as host 416 of FIG. 7 and/or host 700 of FIG. 10) discussed in the preceding paragraphs will now be described with reference to FIG. 12.

Like host 700, embodiments of host 902 include hardware, such as a communication interface, processing circuitry, and memory. The host 902 also includes software, which is stored in or accessible by the host 902 and executable by the processing circuitry. The software includes a host application that may be operable to provide a service to a remote user, such as the UE 906 connecting via an over-the-top (OTT) connection 950 extending between the UE 906 and host 902. In providing the service to the remote user, a host application may provide user data which is transmitted using the OTT connection 950.

The network node 904 includes hardware enabling it to communicate with the host 902 and UE 906. The connection 960 may be direct or pass through a core network (like core network 406 of FIG. 7) and/or one or more other intermediate networks, such as one or more public, private, or hosted networks. For example, an intermediate network may be a backbone network or the Internet.

The UE 906 includes hardware and software, which is stored in or accessible by UE 906 and executable by the UE's processing circuitry. The software includes a client application, such as a web browser or operator-specific “app” that may be operable to provide a service to a human or non-human user via UE 906 with the support of the host 902. In the host 902, an executing host application may communicate with the executing client application via the OTT connection 950 terminating at the UE 906 and host 902. In providing the service to the user, the UE's client application may receive request data from the host's host application and provide user data in response to the request data. The OTT connection 950 may transfer both the request data and the user data. The UE's client application may interact with the user to generate the user data that it provides to the host application through the OTT connection 950.

The OTT connection 950 may extend via a connection 960 between the host 902 and the network node 904 and via a wireless connection 970 between the network node 904 and the UE 906 to provide the connection between the host 902 and the UE 906. The connection 960 and wireless connection 970, over which the OTT connection 950 may be provided, have been drawn abstractly to illustrate the communication between the host 902 and the UE 906 via the network node 904, without explicit reference to any intermediary devices and the precise routing of messages via these devices.

As an example of transmitting data via the OTT connection 950, in step 908, the host 902 provides user data, which may be performed by executing a host application. In some embodiments, the user data is associated with a particular human user interacting with the UE 906. In other embodiments, the user data is associated with a UE 906 that shares data with the host 902 without explicit human interaction. In step 910, the host 902 initiates a transmission carrying the user data towards the UE 906. The host 902 may initiate the transmission responsive to a request transmitted by the UE 906. The request may be caused by human interaction with the UE 906 or by operation of the client application executing on the UE 906. The transmission may pass via the network node 904, in accordance with the teachings of the embodiments described throughout this disclosure. Accordingly, in step 912, the network node 904 transmits to the UE 906 the user data that was carried in the transmission that the host 902 initiated, in accordance with the teachings of the embodiments described throughout this disclosure. In step 914, the UE 906 receives the user data carried in the transmission, which may be performed by a client application executed on the UE 906 associated with the host application executed by the host 902.

In some examples, the UE 906 executes a client application which provides user data to the host 902. The user data may be provided in reaction or response to the data received from the host 902. Accordingly, in step 916, the UE 906 may provide user data, which may be performed by executing the client application. In providing the user data, the client application may further consider user input received from the user via an input/output interface of the UE 906. Regardless of the specific manner in which the user data was provided, the UE 906 initiates, in step 918, transmission of the user data towards the host 902 via the network node 904. In step 920, in accordance with the teachings of the embodiments described throughout this disclosure, the network node 904 receives user data from the UE 906 and initiates transmission of the received user data towards the host 902. In step 922, the host 902 receives the user data carried in the transmission initiated by the UE 906.

One or more of the various embodiments improve the performance of OTT services provided to the UE 906 using the OTT connection 950, in which the wireless connection 970 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 902. As another example, the host 902 may process audio and video data which may have been retrieved from a UE for use in creating maps. As another example, the host 902 may collect and analyze real-time data to assist in controlling vehicle congestion (e.g., controlling traffic lights). As another example, the host 902 may store surveillance video uploaded by a UE. As another example, the host 902 may store or control access to media content such as video, audio, VR or AR which it can broadcast, multicast or unicast to UEs. As other examples, the host 902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 950 between the host 902 and UE 906, in response to variations in the measurement results. The measurement procedure and/or the network functionality for reconfiguring the OTT connection may be implemented in software and hardware of the host 902 and/or UE 906. In some embodiments, sensors (not shown) may be deployed in or in association with other devices through which the OTT connection 950 passes; the sensors may participate in the measurement procedure by supplying values of the monitored quantities exemplified above, or supplying values of other physical quantities from which software may compute or estimate the monitored quantities. The reconfiguring of the OTT connection 950 may include message format, retransmission settings, preferred routing etc.; the reconfiguring need not directly alter the operation of the network node 904. Such procedures and functionalities may be known and practiced in the art. In certain embodiments, measurements may involve proprietary UE signaling that facilitates measurements of throughput, propagation times, latency and the like, by the host 902. The measurements may be implemented in that software causes messages to be transmitted, in particular empty or ‘dummy’ messages, using the OTT connection 950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

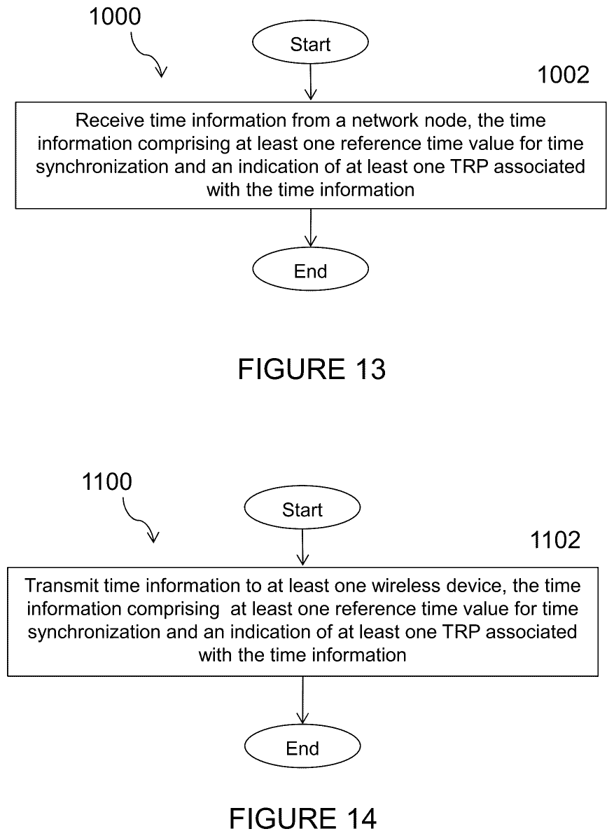

FIG. 13 illustrates a method 1000 by a wireless device 412 for time synchronization, according to certain embodiments. The method includes receiving time information from a network node 410, at step 1002. The time information includes at least one reference time value for time synchronization and an indication of at least one TRP associated with the time information.

In a particular embodiment, the indication identifies a first TRP that is operating as a primary TRP for a cell in which the wireless device is located.

In a particular embodiment, the wireless device 412 uses the at least one reference time value to track a boundary of a system frame structure to derive a reference time associated with the at least one TRP.

In a particular embodiment, the indication identifies at least one physical cell identifier, and wherein each physical cell identifier is associated with a particular TRP.

In a particular embodiment, the indication comprises a SSB index associated with the TRP.

In a particular embodiment, the indication comprises a plurality of SSB indices, and each one of the plurality of SSB indices is associated with a respective one of a plurality of TRPs.

In a particular embodiment, the timing information comprises a plurality of reference time values, and wherein each one of the plurality of reference time values is associated with a respective one of a plurality of TRPs.

In a particular embodiment, at least one of the plurality of TRPs operates as a secondary TRP for the cell.

FIG. 14 illustrates a method 1100 by a network node 410 for provisioning of reference time for time synchronization, according to certain embodiments. The method includes transmitting time information to at least one wireless device 412, at step 1102. The time information includes at least one reference time value for time synchronization and an indication of at least one transmission/reception point, TRP, associated with the time information.

In a particular embodiment, the indication identifies a first TRP that is operating as a primary TRP for a cell in which the wireless device is located.

In a particular embodiment, the indication identifies at least one physical cell identifier, and wherein each physical cell identifier is associated with a particular TRP.

In a particular embodiment, the indication comprises a synchronization signal block, SSB, index associated with the TRP.

In a particular embodiment, the indication comprises a plurality of SSB indices, and each one of the plurality of SSB indices is associated with a respective one of a plurality of TRPs.

In a particular embodiment, the timing information comprises a plurality of reference time values, and wherein each one of the plurality of reference time values is associated with a respective one of a plurality of TRPs.

In a particular embodiment, the network node 410 designates, from the plurality of TRPs, at least one of the primary TRP, and the at least one secondary TRP.

In a particular embodiment, the primary TRP is determined based on at least one of a geographic location of each of the plurality of TRPs, a cost of maintaining each TRP at a minimum level of clock accuracy, and an ability of each TRP of the plurality of TRPs to access to an external time reference.

In a particular embodiment, the network node 410 configures the at least one wireless device to use the at least one reference time value to track a boundary of a system frame structure to derive a reference time associated with the at least one TRP.

In a particular embodiment, the network node 410 communicates the time information and the indication of the at least one TRP associated with the time information between a distributed unit, DU, of the network node and a control unit, CU, of the network node 410.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Example Embodiments

### Group A Example Embodiments

Example Embodiment A1. A method by a wireless device for provisioning of reference time for time synchronization, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for provisioning of reference time for time synchronization, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a wireless device for time synchronization, the method comprising: receiving time information from a network node, the time information comprising: at least one reference time for time synchronization; and an indication of at least one transmission/reception point (TRP) associated with the time information.

Example Embodiment C2. The method of Example Embodiment C1, wherein the time information and the indication are transmitted via a broadcast transmission to a group of wireless devices in at least one cell served by the network node.

Example Embodiment C3. The method of any one of Example Embodiments C1 to C2, wherein the indication comprises a synchronization signal block (SSB) index associated with the TRP.

Example Embodiment C4. The method of any one of Example Embodiments C1 to C2, wherein the indication comprises a plurality of SSB indices, and wherein each one of the plurality of SSB indices is associated with a respective one of a plurality of TRPs.

Example Embodiment C5. The method of any one of Example Embodiments C1 to C4, wherein the indication identifies at least one physical cell identifier, and wherein each physical cell identifier is associated with a particular TRP.

Example Embodiment C6. The method of any one of Example Embodiments C3 to C5, wherein the indication identifies a first TRP that is operating as a primary TRP for a cell in which the wireless device is located.

Example Embodiment C7. The method of Example Embodiment C6, wherein at least one additional TRP operates as a secondary TRP for the cell.

Example Embodiment C8. The method of any one of Example Embodiments C6 to C7, wherein the timing information is received from the primary TRP.

Example Embodiment C9. The method of any one of Example Embodiments C6 to C7, wherein the timing information is received from a secondary TRP.

Example Embodiment C10. The method of any one of Example Embodiments C1 to C9, wherein the timing information is received via a Radio Resource Control (RRC) message.

Example Embodiment C11. The method of any one of Example Embodiments C1 to C10, wherein the at least one reference time comprises at least one reference time value.

Example Embodiment C12. The method of any one of Example Embodiments C1 to C10, wherein the timing information comprises a plurality of reference time values, and wherein each one of the plurality of reference time values is associated with a respective one of a plurality of TRPs.

Example Embodiment C13. The method of any one of Example Embodiments C1 to C12, further comprising: determining, based on the timing information, a propagation delay for a communication channel between the at least one wireless device and the at least one TRP.

Example Embodiment C14. The method of any one of Example Embodiments C1 to C13, further comprising: determining, based on the timing information, a plurality of propagation delays, and wherein each one of the plurality of propagation delays is associated with a respective one of a plurality of communication channels between the at least one wireless device and a respective one of a plurality of TRPs.

Example Embodiment C15. The method of Example Embodiments C13 to C14, wherein determining the propagation delay and/or the plurality of propagation delays comprises calculating the propagation delay and/or the plurality of propagation delays.

Example Embodiment C16. The method of any one of Example Embodiments C1 to C15, further comprising using the time information to track a boundary of a system frame structure to derive the reference time value.

Example Embodiment C17. The method of Example Embodiments C1 to C16, further comprising: providing user data; and forwarding the user data to a host via the transmission to the network node.

Example Embodiment C18.A user equipment comprising processing circuitry configured to perform any of the methods of Example Embodiments C1 to C17.

Example Embodiment C19.A wireless device comprising processing circuitry configured to perform any of the methods of Example Embodiments C1 to C17.

Example Embodiment C20. A computer program comprising instructions which when executed on a computer perform any of the methods of Example Embodiments C1 to C17.

Example Embodiment C21. A computer program product comprising computer program, the computer program comprising instructions which when executed on a computer perform any of the methods of Example Embodiments C1 to C17.

Example Embodiment C22.A non-transitory computer readable medium storing instructions which when executed by a computer perform any of the methods of Example Embodiments C1 to C17.

### Group D Example Embodiments

Example Embodiment D1. A method by a network node for provisioning of reference time for time synchronization, the method comprising: transmitting time information to at least one wireless device, the time information comprising: at least one reference time for time synchronization; and an indication of at least one transmission/reception point (TRP) associated with the time information.

Example Embodiment D2. The method of Example Embodiment D1, wherein the time information and the indication are transmitted via a broadcast transmission to a group of wireless devices in at least one cell served by the network node.

Example Embodiment D3. The method of any one of Example Embodiments D1 to D2, wherein the indication comprises a synchronization signal block (SSB) index associated with the TRP.

Example Embodiment D4. The method of any one of Example Embodiments D1 to D2, wherein the indication comprises a plurality of SSB indices, and wherein each one of the plurality of SSB indices is associated with a respective one of a plurality of TRPs.

Example Embodiment D5. The method of any one of Example Embodiments D1 to D4, wherein the indication identifies at least one physical cell identifier, and wherein each physical cell identifier is associated with a particular TRP.

Example Embodiment D6. The method of any one of Example Embodiments D3 to D5, wherein the indication identifies a first TRP that is operating as a primary TRP for a cell in which the wireless device is located.

Example Embodiment D7. The method of Example Embodiment D6, wherein at least one additional TRP operates as a secondary TRP for the cell.

Example Embodiment D8. The method of any one of Example Embodiments D6 to D7, wherein the timing information is transmitted to the wireless device via the primary TRP.

Example Embodiment D9. The method of any one of Example Embodiments D6 to D7, wherein the timing information is transmitted to the wireless device via a secondary TRP.

Example Embodiment D10. The method of any one of Example Embodiments D7 to D9, further comprising designating, from a plurality of TRPs, at least one of the primary TRP, and the at least one secondary TRP.

Example Embodiment D11. The method of Example Embodiment D10, wherein the primary TRP is determined based on at least one of a geographic location of each of the plurality of TRPs, a cost of maintaining each TRP at a minimum level of clock accuracy, and an ability of each TRP of the plurality of TRPs to access to an external time reference.

Example Embodiment D12. The method of any one of Example Embodiments D1 to D11, wherein the timing information is received via a Radio Resource Control (RRC) message.

Example Embodiment D13. The method of any one of Example Embodiments D1 to D12, wherein the at least one reference time comprises at least one reference time value.

Example Embodiment D14. The method of any one of Example Embodiments D1 to D12, wherein the timing information comprises a plurality of reference time values, and wherein each one of the plurality of reference time values is associated with a respective one of a plurality of TRPs.

Example Embodiment D15. The method of any one of Example Embodiments D1 to D14, further comprising configuring the at least one wireless device to determine a propagation delay for a communication channel between the at least one wireless device and the at least one TRP.

Example Embodiment D16. The method of any one of Example Embodiments D1 to D14, further comprising configuring the at least one wireless device to determine a plurality of propagation delays, each one of the plurality of propagation delays being associated with a communication channel between the at least one wireless device and a respective one of a plurality of TRPs.

Example Embodiment D17. The method of any one of Example Embodiments D1 to D16, further comprising communicating the time information between a distributed unit (DU) of the network node and a control unit (CU) of the network node.

Example Embodiment D18. The method of any one of Example Embodiments D1 to D17, wherein the network node comprises a gNodeB (gNB).

Example Embodiment D19. The method of any of the previous Example Embodiments, further comprising: obtaining user data; and forwarding the user data to a host or a user equipment.

Example Embodiment D20. A network node comprising processing circuitry configured to perform any of the methods of Example Embodiments D1 to D19.

Example Embodiment D21. A computer program comprising instructions which when executed on a computer perform any of the methods of Example Embodiments D1 to D19.

Example Embodiment D22. A computer program product comprising computer program, the computer program comprising instructions which when executed on a computer perform any of the methods of Example Embodiments D1 to D19.

Example Embodiment D23. A non-transitory computer readable medium storing instructions which when executed by a computer perform any of the methods of Example Embodiments D1 to D19.

### Group E Example Embodiments

Example Embodiment E1. A user equipment for provisioning of reference time for time synchronization, comprising: processing circuitry configured to perform any of the steps of any of the Group A and C Example Embodiments; and power supply circuitry configured to supply power to the processing circuitry.

Example Embodiment E2. A network node for provisioning of reference time for time synchronization, the network node comprising: processing circuitry configured to perform any of the steps of any of the Group B and D Example Embodiments; power supply circuitry configured to supply power to the processing circuitry.

Example Embodiment E3. A user equipment (UE) for provisioning of reference time for time synchronization, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Embodiment E10.A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Embodiment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13.A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16.A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18.A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.

Example Embodiment E19. The method of the previous Example Embodiment, further comprising, at the network node, transmitting the user data provided by the host for the UE.

Example Embodiment E20. The method of any of the previous 2 Example Embodiments, wherein the user data is provided at the host by executing a host application that interacts with a client application executing on the UE, the client application being associated with the host application.

Example Embodiment E21.A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment E22. The communication system of the previous Example Embodiment, further comprising: the network node; and/or the user equipment.

Example Embodiment E23.A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26.A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B and D Example Embodiments to receive the user data from the UE for the host.

Example Embodiment E27. The method of the previous Example Embodiment, further comprising at the network node, transmitting the received user data to the host.

### ADDITIONAL INFORMATION

### Propagation Delay Compensation Enhancements for Time Synchronization

### Introduction

SA2 Rel-17 calls for a new use case for TSN Grandmaster clocks supported within the context of TSN-5GS interworking wherein TSN Grandmaster clocks are located at end stations connected to UE/DS-TTs. This new Rel-17 use case involves two Uu interfaces in the 5GS path (i.e. 5GS ingress to the 5GS egress) over which a TSN Grandmaster clock is relayed. Considering that up to 540 ns of uncertainty can be introduced by a single Uu interface when using the legacy Timing Advance method to determine the downlink propagation delay as indicated by [4], supporting a 5GS path that includes two Uu interfaces will be problematic when the maximum allowed uncertainty allowed over the 5GS path is limited to 900 ns for the control-to-control scenario. For the Rel-17 URLLC/IIoT WI, RAN1 is directed to investigate possible enhancements in the following area:
Propagation delay compensation enhancements (including mobility issues, if any). [RAN2, RANT, RAN3, RAN4]

Possible enhancements to the legacy Timing Advance method as well as the possible use of an enhanced RTT method to determine the total uncertainty introduced per Uu interface have been discussed in RAN1. In this contribution, we investigate further the accuracy achievable via the TA-based method and the RTT-based method for propagation delay estimation.

### Time Synchronization Error

An example of the two Uu interface use case is illustrated in FIG. 15, wherein two UEs can be connected to different gNBs, thereby introducing the potential for increased uncertainty compared to the case where each UE is connected to the same gNB. Specifically, FIG. 15 illustrates TSN E2E timing delivery case 2 with ingress at the UE.

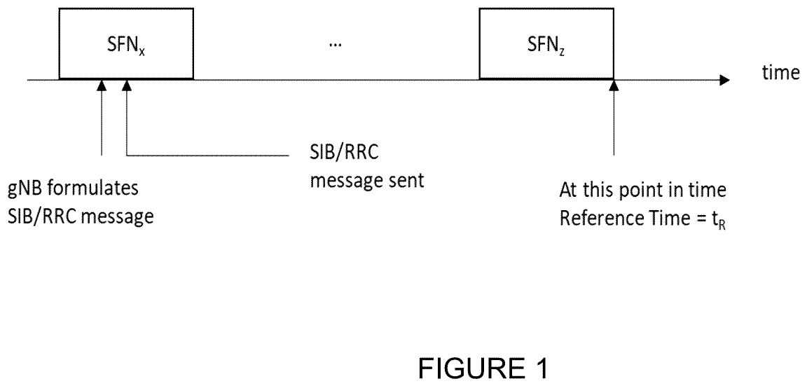

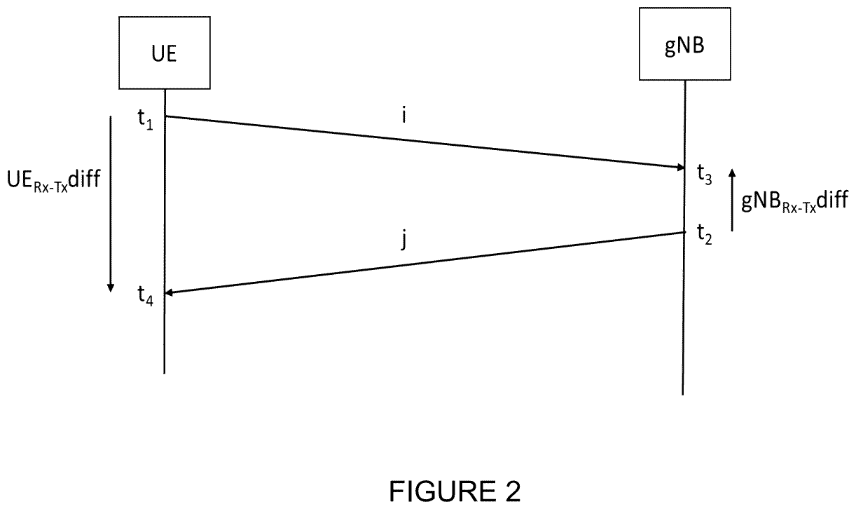

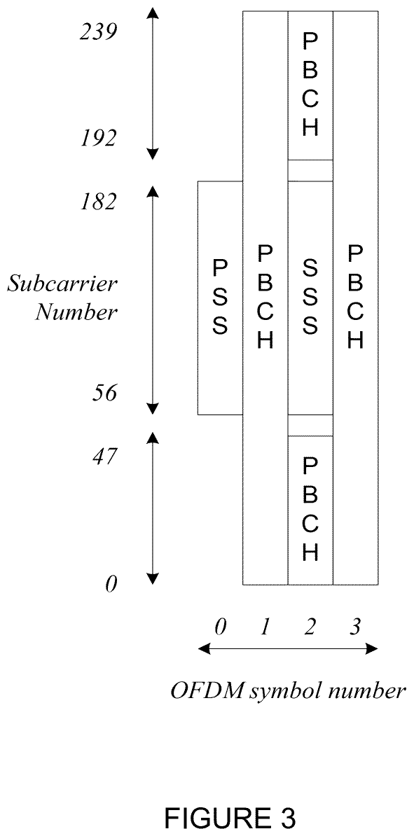

The 5GS synchronicity budget requirement can be as low as 900 ns in what is currently the most demanding TSN—5GS integration use case and represents the portion of the end-to-end synchronicity budget applicable between the ingress and egress of the 5G system (see FIG. 1). The per Uu interface synchronization error represents a portion of the end-to-end synchronicity budget and consists of the uncertainty introduced when (a) sending the 5G reference time from gNB antenna to the UE antenna by including ReferenceTimeInfo in either a DLInformationTransfer RRC message or SIB9 and then (b) adjusting the 5G reference time to reflect the downlink propagation delay.

In RAN1 #102e, it was agreed that both control-to-control and smart-grid use cases are used as representative cases for study, where:
One Uu interface is assumed for smart grid.
Two Uu interfaces are assumed for control-to-control.

A first approach is to pursue a single set of Rel-17 PDC (propagation delay compensation) enhancements that can adopted for supporting both use cases above. Following this approach RAN1 only needs to come up with a single PDC method that satisfies the most stringent Rel-17 use case requirements, where the same method can be applied to support all other use cases as well.

A second approach is to use the legacy TA-based method in support of use cases having a less demanding PDC uncertainty requirement and supplement it with a new method for supporting use cases having the most demanding PDC uncertainty requirements.

Either way, it is necessary to adopt a method for Rel-17 that is capable of satisfying the most demanding time synchronization requirement of TSN use cases.

The range of uncertainty for a single Uu interface shown in Table 2 above was agreed at 3GPP TSG-RAN WG2 #113-e. Thus RANT should specify a method that can satisfy the requirement for the control-to-control use case (i.e., 900 ns 5GS uncertainty budget with two Uu interfaces).

It is proposed to adopt a PDC method for Rel-17 that satisfies the single Uu interface budget of ±145 ns to ±275 ns.

### Time Synchronization Error if Using the TA-Based Propagation Delay Estimation

For the TA-based method, the formula of Alt 1 for TA-based method was agreed in RAN1 #106bis and shown below:

$$\begin{matrix}{error}_{total , {TA}_{based}} \leq \\ {error}_{BS , DL , TX} + {error}_{UE , DL , TX} + {error}_{BS , DL , TX} + \\ {error}_{UE , DL , TX} + {error}_{UE , UL , TX} + {error}_{BS , UL , RX} + {error}_{{TA}_{indication}}\end{matrix} = {error}_{BS , DL , TX} + {error}_{UE , DL , TX} + \frac{{error}_{BS , DL , TX} + {T}_{e} + {error}_{BS , UL , RX} + {error}_{{TA}_{indication}}}{2} \qquad ( 1 )$$

Here the RAN4 input is taken into account: error_{UE,DL,RX}+error_{UE, UL, TX}<Te

The error components of the formula are discussed below:
(a) error_{BS,DL,TX}: The uncertainty due to the value of the 5G reference time indicated by the gNB as being applicable to the end of SFNx not reflecting the actual 5G reference time value when the end of SFNx occurs at the gNB Antenna Reference Point (ARP). The value error_{BS,DL,TX}=E65 ns, per agreement at RAN WG1 #103e.
(b) error_{UE,DL,RX}: The uncertainty associated with UE downlink frame timing detection. As a worst case, a UE synchronizes to the DL using Sync Signal Block (SSB) received within the last 160 ms, where SSB contains information identifying specific DL frame and slot numbering. As described in [13] and [14], the minimum DL frame timing detection error (without any margin) is inverse of the DL BW of the signals used for timing estimation. When using SSB as DL signal for timing estimation, the minimum error is calculated in Table 3 below.

TABLE 3
DL frame timing detection error at UE, based on SSB detection

| #PRB of | | PBCH BW | |
|---|---|---|---|
| PBCH (=240 | SCS | (MHz) = 240 * | Min Timing Error (sec) = 0.5/ |
| subcarrier) | (kHz) | SCS | (PBCH BW) |
| 20 | 15 | 3.6 | 0.139 us = 4.27 Ts = 273 Tc |
| 20 | 30 | 7.2 | 0.069 us = 2.13 Ts = 137 Tc |
| 20 | 60 | 14.4 | 0.035 us = 1.07 Ts = 69 Tc |
| 20 | 120 | 28.8 | 0.017 us = 0.53 Ts = 34 Tc |

Thus, for estimation purpose, the following can be assumed for PD estimation:

$${error}_{UE , DL , RX} = \pm 139 ns and 139 ns for 15 kHz DL SCS , respectively$$

It should be emphasized that the values in Table 3 are only theoretically possible minimum timing detection error, and very optimistic. For example, while the UE performance in AWGN channel may be close to these values, the timing detection error caused by multipath channel is not taken into account, even though the error by multipath likely dominates. Thus the values in Table 3 provide a reference value for RAN1 estimation, with the understanding that actual values, if they are to be specified, are up to RAN4 discussion.
(c) Tₑ: The error when a UE performs transmission of UL frames after acquiring the first detected path of the corresponding downlink frame and applying the most recently received TA information. According to the Tₑ values tabulated in TS 38.133, the following values are considered.

$${T}_{e} = \pm 12 * 64 * Tc = 768 * Tc = \pm 391 ns ( assuming 15 kHz SCS for SSB signals , 15 kHz SCS for uplink signals )$$

$${T}_{e} = \pm 8 * 64 * Tc = 512 * Tc = \pm 260 ns ( assuming 30 kHz SCS for SSB signals , 30 kHz SCS for uplink signals )$$

(d) error_{BS,UL,RX}: The uncertainty with which a gNB acquires UL frame timing based on UL reference signal like SRS. According to agreement from RAN1 #102e, the following value is assumed:

$${error}_{BS , UL , RX} = \pm 100 ns ( per agreement at RAN WG 1 \#102 e )$$

(e) Err_{TA}_{_{indication}}: The uncertainty due to timing advance (TA) command granularity. Maximum value of this uncertainty is half of TA command granularity in the existing NR specification where p represents the SCS of the DL cell:

$${error}_{{TA}_{indication}} = \pm 8 * 64 * Tc / {2}^{μ} = 512 * Tc = \pm 260 ns ( μ = 0 for 15 kHz SCS )$$

$${error}_{{TA}_{indication}} = \pm 8 * 64 * Tc / {2}^{μ} = 256 * Tc = \pm 130 ns ( μ = 1 for 30 kHz SCS )$$

Overall, for the TA-based propagation delay compensation method, the total time synchronization error of a single Uu interface is summarized in Table 4 for SCS of 15 kHz and 30 kHz, respectively.

Table 4. Error components and total time synchronization error (based on Alt 1) for the TA-based propagation delay compensation method.

| | Value (ns) for | | Value (ns) | |
|---|---|---|---|---|
| Error components | SCS = 15 kHz | | SCS = 30 kHz | |
| error_{BS, DL, TX} | ±65 | ns | ±65 | ns |
| error_{UE, DL, RX} | ±139 | ns | ±69 | ns |
| Tₑ | ±768*Tc = ±391 ns | | ±512*Tc = ±260 ns | |
| error_{BS, UL, RX} | ±100 | ns | ±100 | ns |
| error_{TA}_{_{indication}} | ±512*Tc = 260 ns | | ±256*Tc = 130 ns | |
| Total error: Err_{total, RTT} _{_{based}} | ±612 | ns | ±412 | ns |

*In the above, time unit T_{c} = 1/(480 · 10³ · 4096) (sec).

Analysis shows that it is not possible to reduce error components Tₑ and error_{TA}_{_{indication}} to satisfy the single Uu interface error budget error_{Uu} in the range of (±145 ns, ±275 ns) for the control-to-control TSN scenario. Thus, the following observations are provided:
Observation 1: With the existing Te and TA command granularity values, for both SCS=15 kHz and 30 kHz, the TA-based method cannot satisfy the Uu interface time synchronization accuracy for the control-to-control scenario.
Observation 2: For SCS=15 kHz, with the TA-based method, it is not possible to reduce Te and TA command granularity values to satisfy the Uu interface time synchronization accuracy for the control-to-control scenario.
Observation 3: For SCS=30 kHz, with the TA-based method, at a minimum, the summation of Te and TA command granularity values need to reduce to approximately ¼ of existing value in order to satisfy the Uu interface time synchronization accuracy for the control-to-control scenario.

Based on the analysis and observations above, RAN1 should not adopt the TA-based method for propagation delay compensation for the control-to-control scenario.

### Time Synchronization Error if Using the RTT-Based Propagation Delay Estimation

For the RTT-based method, the formula of Alt 1 for RTT-based method was agreed in RAN1 #106bis and shown below:

$${error}_{total , {RTT}_{based}} \leq {error}_{BS , DL , TX} + {error}_{UE , DL , TX} + \frac{1}{2} ( {error}_{gNB , RxTxDiff} + {error}_{UE , RxTxDiff} + {error}_{RxTxDiff\_indication} )$$

The error components of the formula are discussed below:
(a) error_{BS,DL,TX}: ±65 ns, the same as that of TA-based method, and according to agreement at RAN WG1 #103e.
(b) error_{UE,DL,RX}: Similar to the method shown in Table 3, the minimum timing detection error at UE can be estimated. DL RS bandwidth used by the RTT-based propagation compensation should be used, instead of PBCH bandwidth. If assuming PRS is used as DL RS, PRB bandwidth of 24 PRB can be used, thus: minimum timing detection error=0.5/(DL RS BW)=0.5/(24*12*SCS). This gives error_{UE,DL,RX}=±116 ns and ±58 ns assuming 15 kHz SCS and 30 kHz SCS for DL RS;
   Note that 24 PRB is the minimum PRB bandwidth in 38.133 V17.3.0, Table 10.1.25.2-2. It is noted that the PRS bandwidth can be as large as 272 PRBs. In general, the larger the bandwidth of the DL reference signal used for timing detection, the smaller the DL timing detection error.
   If TRS is used instead of PRS, value of error_{UE,DL,RX} may be different. In general, the gNB has the flexibility to configure the TRS bandwidth such that it is adequate for achieving the desired time synchronization accuracy target.
(c) error_{gNB,RxTxDiff}: The gNB Rx-Tx time difference absolute accuracy has been finalized in TS 38.133 v17.3.0, where the measurement accuracy is given for various combinations of SRS Ês/lot and SRS bandwidth. Using the largest error values for SCS=15 kHz and 30 kHz, error_{gNB,RxTxDiff}=±123*Tc and ±42*Tc, respectively.
(d) error_{UE,RxTxDiff}: While the UE Rx-Tx time difference measurement accuracy is not yet finalized, the tentative values in TS 38.133 V17.3.0 are adequate for RAN1 estimation. Using the largest error values for SCS=15 kHz and 30 kHz in TS 38.133 v17.3.0 Table 10.1.25.2-2 for FR1 in fading, error_{UE,RxTxDiff}=±137*Tc and ±87*Tc, respectively.
(e) error_{RxTxDiff,indication}: In 38.133, report mapping tables are provided for gNB Rx-Tx time difference where the granularity ranges from 1*Tc to 32*Tc. Thus it is assumed that the largest and second largest granularity of 32*Tc and 16*Tc are used for SCS=15 kHz and 30 kHz, respectively. Using half of the granularity as indication error, then error_{RxTxDiff,indication}=16*Tc and 8*Tc are used for SCS =15 kHz and 30 kHz, respectively.

Overall, the total time sync error for the RTT-based propagation delay compensation method is summarized in Table 5 for SCS of 15 kHz and 30 kHz, respectively. The calculation shows, tor both SCS=15 kHz and 30 kHz, RTT-based propagation delay estimation can satisfy the Uu interface time synchronization error budget of 145 ns to +275 ns for control-to-control use case.

It is noted that, the estimation in Table 5 is conservative. For example, error_{UE,DL,RX} is estimated using the smallest PRS bandwidth, and the worst accuracy values are taken for both error_{gNB,RxTxDiff} and error_{UE,RxTxDiff}. These error components can be reduced significantly if the gNB configures larger bandwidth for the reference signals used for measurements, i.e., SRS on the uplink, PRS or TRS on the downlink. Thus, RTT-based method has the potential to achieve even tighter synchronization requirements than the control-to-control use case. Thus, RTT-based method is good for future evolution of timing synchronization on the Uu interface.

TABLE 5
Error components and total time synchronization error (based on
Alt 1) for the RTT- based propagation delay compensation method.

| | Value (ns) for | | Value (ns) | |
|---|---|---|---|---|
| Error components | SCS = 15 kHz | | SCS = 30 kHz | |
| error_{BS, DL, TX} | ±65 | ns | ±65 | ns |
| error_{UE, DL, RX} | ±116 | ns | ±58 | ns |
| error_{gNB, RxTxDiff} | ±123*Tc = ±63 ns | | ±42*Tc = ±21 ns | |
| error_{UE, RxTxDiff} | ±137*Tc = ±70 ns | | ±87*Tc = ±44 ns | |
| error_{RxTxDiff, indication} | ±16*Tc = ±8 ns | | ±8*Tc = ±4 ns | |
| Total error: Err_{total, RTT} _{_{based}} | ±251 | ns | ±158 | ns |

*In the above, time unit T_{c} = 1/(480 · 10³ · 4096) (sec).

It is observed that, for both SCS=15 kHz and 30 kHz, RTT-based propagation delay estimation can satisfy the Uu interface time synchronization error budget of ±145 ns to ±275 ns for control-to-control use case.

The actual accuracy of the RTT-based method is adjustable since the DL RS (PRS or TRS) bandwidth and UL RS (i.e., SRS) bandwidth are configurable by gNB. Other parameters are also configurable, for example, the time-domain repetitions can be configured to achieve adequate SINR level. Thus, with the knowledge of the time synchronization requirement (which can be obtained from the core network, for example), the gNB can configure the reference signals properly to achieve the 900 ns time synchronization accuracy target in Rel-17. When necessary, the gNB also has the flexibility to configure the reference signals to satisfy even more stringent requirement in the future.

It is observed that, for RTT-based propagation delay estimation, the gNB can configure DL RS (PRS or TRS) and UL SRS parameters (e.g., bandwidth) according to the desired Uu synchronization accuracy target.

Based on the discussion above, it is proposed that RAN1 adopts an RTT-based procedure for determining propagation delay compensation in support of the most demanding PDC accuracy requirements in Rel-17.

### Design Details of RTT-based Method

### Detection of Reference Time

The reference time information (referenceTimelnfo) is provided by gNB via RRC message, where the reference time providing the time at the ending boundary of a system frame, see the quoted text in the Appendix. Hence the detection of the reference time depends on SSB detection, since SSB provides SFN information.

According to 38.211, PSS, SSS and PBCH within an SS/PBCH block are QCL, while different SS/PBCH blocks cannot be assumed QCL. Thus different SSB in the SSB burst can be transmitted from different TRP. For data communication purpose, it is only required that DL signal from different TRPs arrive at the UE within a CP for coherent detection. However, CP duration is 4.69 μs and 2.34 μs for SCS=15 kHz and 30 kHz, respectively, see Table 4. Compared with the Uu interface time synchronization accuracy requirement (100s of ns), CP duration is order of magnitude too large. This means that the timing at different TRPs cannot be assumed to be synchronized to satisfy the tight clock synchronization needs shown in Table 1. The μs-level time difference detected by SSB at different TRP can overwhelm the propagation delay estimation accuracy.

For any UE, propagation delay should be measured from the TRP that the reference time (referenceTimelnfo) is associated with, regardless of the spatial configuration for data communication.

At physical layer specifications, TRP is not explicitly described. Instead, the TRP is indirectly identified via the SSB index(es) associated with the TRP. Consequently, it is necessary to clarify which SSB(s) the UE should use to detect SFN, so that gNB and UE know which TRP provides the reference time at the desired SFN boundary.

It is proposed to clarify the TRP that referenceTimelnfo is associated with via its SSB index(es).

Additionally, to ensure that the measured propagation delay is for the radio path from the same TRP (e.g., TRP1) used for reference time detection, the DL RS (TRS or PRS) for time synchronization should be QCL-ed with the SSB(s) of the same TRP (e.g., TRP1). Similarly, the SRS should also have the spatial relationship to the same TRP (e.g., TRP1). This is illustrated in FIG. 4. Given that the reference time (T_{ref}) is the time at TRP1, both UEₐ and UE_{b} should measure their propagation delay, T_{p,a} and T_{p,b}, from TRP1, so that the clock time at UEₐ and UE_{b} can be correctly estimated as T_{ref}+T_{p,a} and T_{ref}+T_{p,b}, respectively. In contrast, if this is not clearly defined, then UE_{b} may mistakenly measure propagation delay from TRP2, while T_{ref} is the time at TRP1. Here TRP2 refers to the node that UE_{b} uses for data communication.

It is proposed to define spatial property of DL RS (TRS or PRS) and SRS to measure the propagation delay from the TRP that referenceTimelnfo is associated with.

TABLE 6
CP duration for different SCS

| | | |
|---|---|---|
| SCS | 15 kHz | 30 kHz |

| | | | | |
|---|---|---|---|---|
| OFDM symbol, duration | 66.67 | μs | 33.33 | μs |

| | | |
|---|---|---|
| Cyclic prefix Samples | 288 | 288 |

| | | | | |
|---|---|---|---|---|
| Cyclic prefix duration | 4.69 | μs | 2.34 | μs |

### TRS Configuration

TRS is CSI-RS for tracking. Currently TRS can be periodic or aperiodic, where the configuration of aperiodic TRS depends on that of periodic TRS. Aperiodic TRS and periodic TRS resource have the same bandwidth (with same RB location) and the aperiodic TRS being configured with qcl-Type set to ‘typeA’ and ‘typeD’, where applicable, with the periodic CSI-RS resources.

For time synchronization purpose, it is beneficial to also support semi-persistent TRS. This allows the gNB to trigger periodic TRS transmission when the TSN UE needs to perform propagation delay compensation, and disable it with DCI when the UE has finished updating the clock time.

It is proposed to introduce semi-persistent TRS for propagation delay compensation.

### PRS Configuration

Currently, for positioning purpose, the configuration parameters of PRS are sent from LMF. When used for time synchronization purpose, PRS configuration should be introduced in RRC signalling, so that the parameters are sent from the gNB to the UE. Only configuration for serving cell PRS is needed, and those of neighbor cells are not needed. Furthermore, the critical parameters are those for sequence generation and time-frequency resources are needed. These parameters include (see TS 38.211):
For pseudo random sequence generation: dl-PRS-SequenceID;
For mapping to physical resources: dl-PRSResourceSymbolOffset, dl-PRS-NumSymbols, dl-PRS-CombSizeN, dl-PRSCombSizeN-AndReOffset, dl-PRS-ResourceBandwidth, dl-PRS-StartPRB, dl-PRS-PointA;
For mapping to slots in a downlink PRS resource set: dl-PRS-Periodicity-and-
ResourceSetSlotOffset, dl-PRSResourceSlotOffset, dl-PRSResourceRepetitionFactor, dl-PRS-ResourceTimeGap;
For defining the quasi co-location information of the DL PRS resource with other reference signals: dl-PRS-QCL-Info;
   Regarding PRS muting, this is for coordinating a UE's PRS reception from different cells, including non-serving cells. Thus, muting related parameters (e.g., dl-PRS-MutingOption1, dl-PRS-MutingOption2) are not needed for propagation delay compensation with the serving cell. For QCL information of PRS, the reference signal can be:
SS/PBCH block, where the SSB index(es) is associated with the TRP of referenceTimelnfo;
TRS

It is proposed to introduce RRC parameters for configuring PRS within the serving cell.

It is proposed that the IE for PRS configuration include parameters for sequence generation, mapping to physical resources, mapping to slots in a downlink PRS resource set, and quasi co-location information.

### SRS Configuration

For positioning purposes, SRS configuration is according to higher layer parameter SRS-PosResource. For time synchronization purpose, a separate SRS configuration is needed to provide SRS configuration, for example, SRS-SyncResource.

If the higher layer parameter spatialRelationlnfoPos is configured, the reference RS can be those used for time synchronization:
SS/PBCH block, where the SSB index(es) is associated with the TRP of referenceTimelnfo;
TRS
PRS
   It is proposed to introduce RRC IE for configuration SRS for time synchronization purpose.

### Measurements Quantity and Reference Point

For the RTT-based method, the relevant measurement quantities are:
(a) UE Rx-Tx time difference
(b) gNB Rx-Tx time difference
   Depending on the entity that performs the propagation delay compensation, either (a) or (b) is reported. For example, if UE is the entity that performs the compensation, then gNB measures Rx-Tx time difference and sends the measurement to the UE.

Both (a) and (b) have been carefully defined in 38.215 for the purpose of positioning, see below. For the time synchronization purpose, the definitions can be reused as is, except that the reference signals should be updated to include those for time synchronization also. Specifically, the yellow highlight sentence for UE Rx-Tx time difference need to be updated to include TRS, and the yellow highlight sentence for UE Rx-Tx time difference need to be updated to include SRS for propagation delay compensation.

In terms of the reference point for measurements, the existing definition should be used, e.g., Rx antenna connector, Tx antenna connector. The reference point cannot be baseband. For example, in the latest RAN4 discussion of reference point for Te, it was agreed to include ‘antenna’ in the Te definition (see R4-2115371).

It is proposed that existing definitions of UE Rx-Tx time difference and gNB Rx-Tx time difference are reused with updates to the DL RS and UL RS description as shown in Table 6 below, which corresponds to TS 37.215 v. 16.4.0.

TABLE 6

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a Transmission |
| | Point (TP) [18], defined by the first detected path in time. |
| | T_{UE-TX} is the UE transmit timing of uplink subframe #j that is closest in time to |
| | the subframe #i received from the TP. |
| | Multiple DL PRS resources can be used to determine the start of one subframe |
| | of the first arrival path of the TP. |
| | For frequency range 1, the reference point for T_{UE-RX} measurement shall be the |
| | Rx antenna connector of the UE and the reference point for T_{UE-TX} |
| | measurement shall be the Tx antenna connector of the UE. For frequency range |
| | 2, the reference point for T_{UE-RX} measurement shall be the Rx antenna of the UE |
| | and the reference point for T_{UE-TX} measurement shall be the Tx antenna of the |
| | UE. |
| Applicable for | RRC_CONNECTED |

| | |
|---|---|
| Definition | The gNB Rx − Tx time difference is defined as T_{gNB-RX} − T_{gNB-TX} |
| | Where: |
| | T_{gNB-RX} is the Transmission and Reception Point (TRP) [18] received timing of |
| | uplink subframe #i containing SRS associated with UE, defined by the first |
| | detected path in time. |
| | T_{gNB-TX} is the TRP transmit timing of downlink subframe #j that is closest in |
| | time to the subframe #i received from the UE. |
| | Multiple SRS resources for positioning can be used to determine the start of one |
| | subframe containing SRS. |
| | The reference point for T_{gNB-RX} shall be: |
| | for type 1-C base station TS 38.104 [9]: the Rx antenna connector, |
| | for type 1-O or 2-O base station TS 38.104 [9]: the Rx antenna (i.e. the |
| | centre location of the radiating region of the Rx antenna), |
| | for type 1-H base station TS 38.104 [9]: the Rx Transceiver Array |
| | Boundary connector. |
| | The reference point for T_{gNB-TX} shall be: |
| | for type 1-C base station TS 38.104 [9]: the Tx antenna connector, |
| | for type 1-O or 2-O base station TS 38.104 [9]: the Tx antenna (i.e. the |
| | centre location of the radiating region of the Tx antenna), |
| | for type 1-H base station TS 38.104 [9]: the Tx Transceiver Array |
| | Boundary connector. |

### CONCLUSION

In the previous sections the problem and potential solutions related to clock synchronization are discussed. The following observations are made:

Observation 1With the existing Te and TA command granularity values, for both SCS =15 kHz and 30 kHz, the TA-based method cannot satisfy the Uu interface time synchronization accuracy for the control-to-control scenario.

Observation 2 . . . For SCS=15 kHz, with the TA-based method, it is not possible to reduce Te and TA command granularity values to satisfy the Uu interface time synchronization accuracy for the control-to-control scenario.

Observation 3 . . . For SCS=30 kHz, with the TA-based method, at a minimum, the summation of Te and TA command granularity values need to reduce to approximately ¼ of existing value in order to satisfy the Uu interface time synchronization accuracy for the control-to-control scenario.

Observation 4 . . . For both SCS=15 kHz and 30 kHz, RTT-based propagation delay estimation can satisfy the Uu interface time synchronization error budget of ±145 ns to ±275 ns for control-to-control use case.

Observation 5 . . . For RTT-based propagation delay estimation the gNB can configure DL RS (PRS or TRS) and UL SRS parameters (e.g., bandwidth) according to the desired Uu synchronization accuracy target.

Observation 6 . . . For any UE, propagation delay should be measured from the TRP that the reference time (referenceTimelnfo) is associated with, regardless of the spatial configuration for data communication.

And the following proposals are made:

Proposal 1 . . . Adopt a PDC method for Rel-17 that satisfies the single Uu interface budget of ±145 ns to ±275 ns.

Proposal 2 . . . RAN1 does not adopt the TA-based method for propagation delay compensation for the control-to-control scenario.

Proposal 3 RAN1 adopts an RTT-based procedure for determining propagation delay compensation in support of the most demanding PDC accuracy requirements in Rel-17.

Proposal 4 . . . Clarify the TRP that referenceTimelnfo is associated with via its SSB index(es).

Proposal 5 . . . Define spatial property of DL RS (TRS or PRS) and SRS to measure the propagation delay from the TRP that referenceTimelnfo is associated with.

Proposal 6 . . . Introduce semi-persistent TRS for propagation delay compensation.

Proposal 7 . . . Introduce RRC parameters for configuring PRS within the serving cell.

Proposal 8 The IE for PRS configuration include parameters for sequence generation, mapping to physical resources, mapping to slots in a downlink PRS resource set, and quasi co-location information.

Proposal 9 . . . Introduce RRC IE for configuration SRS for time synchronization purpose.

Proposal 10 . . . Existing definitions of UE Rx-Tx time difference and gNB Rx-Tx time difference are reused with updates to the DL RS and UL RS description.

1. A method by a wireless device for time synchronization, the method comprising:
receiving time information from a network node, the time information comprising:
at least one reference time value for time synchronization; and
an indication of at least one transmission/reception point, TRP, associated with the time information.

2. The method of claim 1, wherein the indication identifies a first TRP that is operating as a primary TRP for a cell in which the wireless device is located.

3. The method of claim 1, further comprising using the at least one reference time value to track a boundary of a system frame structure to derive a reference time associated with the at least one TRP.

4.-8. (canceled)

9. A method by a network node for provisioning of reference time for time synchronization, the method comprising:
transmitting time information to at least one wireless device, the time information comprising:
at least one reference time value for time synchronization; and
an indication of at least one transmission/reception point, TRP, associated with the time information.

10.-18. (canceled)

19. A wireless device for time synchronization, the wireless device configured to:
receive time information from a network node, the time information comprising:
at least one reference time value for time synchronization; and
an indication of at least one transmission/reception point, TRP, associated with the time information.

20. The wireless device of claim 19, wherein the indication identifies a first TRP that is operating as a primary TRP for a cell in which the wireless device is located.

21. The wireless device of claim 19, wherein the wireless device is configured to use the at least one reference time value to track a boundary of a system frame structure to derive a reference time associated with the at least one TRP.

22. The wireless device of claim 19, wherein the indication identifies at least one physical cell identifier, and wherein each physical cell identifier is associated with a particular TRP.

23. The wireless device of claim 19, wherein the indication comprises a synchronization signal block, SSB, index associated with the TRP.

24. The wireless device of claim 19, wherein the indication comprises a plurality of SSB indices, and wherein each one of the plurality of SSB indices is associated with a respective one of a plurality of TRPs.

25. The wireless device of claim 19, wherein the timing information comprises a plurality of reference time values, and wherein each one of the plurality of reference time values is associated with a respective one of a plurality of TRPs.

26. The wireless device of claim 25, wherein at least one of the plurality of TRPs operates as a secondary TRP for the cell.

27. A network node for provisioning of reference time for time synchronization, the network node configured to:
transmit time information to at least one wireless device, the time information comprising:
at least one reference time value for time synchronization; and
an indication of at least one transmission/reception point, TRP, associated with the time information.

28. The network node of claim 27, wherein the indication identifies a first TRP that is operating as a primary TRP for a cell in which the wireless device is located.

29. The network node of claim 27, wherein the indication identifies at least one physical cell identifier, and wherein each physical cell identifier is associated with a particular TRP.

30. The network node of claim 27, wherein the indication comprises a synchronization signal block, SSB, index associated with the TRP.

31. The network node of claim 27, wherein the indication comprises a plurality of SSB indices, and wherein each one of the plurality of SSB indices is associated with a respective one of a plurality of TRPs.

32. The network node of claim 27, wherein the timing information comprises a plurality of reference time values, and wherein each one of the plurality of reference time values is associated with a respective one of a plurality of TRPs.

33. The network node of claim 32, wherein the network node is configured to designate, from the plurality of TRPs, at least one of:
the primary TRP, and
the at least one secondary TRP.

34. The network node of claim 33, wherein the primary TRP is determined based on at least one of:
a geographic location of each of the plurality of TRPs,
a cost of maintaining each TRP at a minimum level of clock accuracy, and
an ability of each TRP of the plurality of TRPs to access to an external time reference.

35. The network node of claim 27, wherein the network node is operable to configure the at least one wireless device to use the at least one reference time value to track a boundary of a system frame structure to derive a reference time associated with the at least one TRP.

36. The network node of claim 28, wherein the network node is configured to communicate the time information and the indication of the at least one TRP associated with the time information between a distributed unit, DU, of the network node and a control unit, CU, of the network node.
